(19) United States
(12) Patent Application Publication
(10) Pub. No.: US 2017/0206732 A1
(43) Pub. Date: Jul. 20, 2017

(54) BANKNOTE HANDLING APPARATUS

(71) Applicant: GLORY LTD., Himeji-shi (JP)

(72) Inventors: Yoshikatsu MIZUSHIMA, Hyogo (JP); Takahiko TAGUCHI, Hyogo (JP); Tsuyoshi IZUMIDA, Hyogo (JP)

(21) Appl. No.: 15/387,757

(22) Filed: Dec. 22, 2016

(30) Foreign Application Priority Data
Jan. 19, 2016 (JP) 2016-007985

(51) Int. Cl. G07D 11/00

(52) U.S. Cl. CPC G07D 11/0072; G07D 11/0036; G07D 11/0045; G07D 11/0078

(57) ABSTRACT

A banknote handling apparatus that obtains information of a banknote and outputs the obtained information at an appropriate time, is provided.

A banknote handling apparatus 100 includes: a recognition unit 3 configured to obtain information of a banknote; a handling unit configured to perform handling on the basis of the information obtained by the recognition unit 3; a control unit 120 configured to output, to an outside, the information obtained by the recognition unit 3; and a condition selection unit configured to select one condition from among a plurality of predetermined conditions, as a condition for outputting the information. The control unit 120 controls a time at which the information is outputted, on the basis of the condition selected by the condition selection unit.

### CROSS REFERENCE TO RELATED APPLICATION

The disclosure of Japanese Patent Application No. 2016-007985, filed on Jan. 19, 2016, is incorporated herein by reference.

### BACKGROUND OF THE INVENTION

Field of the Invention

The technique disclosed herein relates to banknote handling apparatuses.

Description of the Background Art

To date, a banknote handling apparatus that obtains information of banknotes and performs handling based on the obtained information, has been known. For example, Japanese Patent No. 4624058 (hereinafter, referred to as Patent Literature 1) discloses a banknote handling machine that includes: recognition means for recognizing information (version (new/old), fitness/unfitness, denomination, and the like) of banknotes; an external stacking unit for stacking the banknotes on the basis of recognition results from the recognition means; and a control unit configured to output (transmit), to the outside (higher-ranking computer or the like), data (confirmed data) including the obtained information, when the banknotes fully stacked in the external stacking unit are removed from the external stacking unit.

### SUMMARY OF THE INVENTION

A time when output of data is required may be different according to application of the banknote handling apparatus, or the like such that, for example, data is required to be outputted before the banknotes are removed, or the output is required to be stopped until a batch process is completed or a user makes an instruction for outputting data even in a case where the banknotes have been removed.

However, in a structure, such as the banknote handling machine disclosed in Patent Literature 1, in which the output is performed under a certain condition, such individual requests cannot be satisfied.

For example, when a batch process for the number of banknotes which exceed a stacking capacity of a stacking unit is performed, stacking and removal of the number of banknotes which are less than or equal to the stacking capacity may be performed a plurality of times in a divided manner. In this case, when the plurality of times of the removals are all completed, data of the banknotes in the batch process is required to be collectively outputted. However, in the banknote handling machine disclosed in Patent Literature 1, data is outputted each time the banknotes are removed. Therefore, data for one batch process may be divided into a plurality of pieces of data.

The technique disclosed herein is made in view of the aforementioned problem, and an object of the technique is to provide a banknote handling apparatus configured to obtain information of banknotes and output the obtained information at an appropriate time.

The technique disclosed herein relates to a banknote handling apparatus of the apparatus.

The banknote handling apparatus includes: a recognition unit configured to obtain information of a banknote; a handling unit configured to perform handling on the basis of the information obtained by the recognition unit; a control unit configured to output, to an outside, the information obtained by the recognition unit; and a condition selection unit configured to select a condition from among a plurality of predetermined conditions, as a condition for outputting the information. The control unit controls a time at which the information is outputted, on the basis of the condition selected by the condition selection unit.

The “information of a banknote” includes: information indicating whether or not the banknote is a rejected note; a currency code; a denomination; a year of issue; data indicating, for example, whether the banknote is a fit note or an unfit note; combination of these pieces of data; and the like.

Further, the “outside” includes, for example, a higher-ranking terminal installed in a center of a financial facility or the like, a display provided in the banknote handling apparatus, and an external display, a printer, and a storage device such as a USB memory, which are connected to the banknote handling apparatus. Therefore, outputting the information to an outside includes: transmitting the information such that the higher-ranking device or the storage device can store the information; displaying the information on the display; and printing the information by the printer.

In this configuration, in the banknote handling apparatus, the handling unit performs the handing on the basis of the information, about the banknote, obtained by the recognition unit, and an output unit outputs the information to the outside of the banknote handling apparatus.

The banknote handling apparatus includes the condition selection unit that selects one condition for outputting the information, from among a plurality of conditions. The control unit controls a time at which the information is outputted, on the basis of the condition selected by the condition selection unit. By such control, for example, the information can be outputted when or after the condition selected by the condition selection unit has been satisfied. Since a time at which the information is outputted can be changed, for example, a condition according to a task performed by using the banknote handling apparatus is selected, whereby the information can be outputted at an appropriate time.

Further, one of the plurality of conditions may be a condition that a batch process in which a set batch quantity of banknotes are stacked in a stacking unit, is completed.

In this configuration, the control unit can output the information to the outside when the batch process has been completed. In this case, the control unit can collectively output the information obtained from each of the stacked banknotes. The information, therefore, is outputted for each batch process, and data of the outputted information, in particular, the number of banknotes can be strictly managed. A batch process is a process where the number of banknotes is set to be less than or equal to the stacking capacity of banknotes stacked in the stacking unit. In such a batch process, the batch number of stacked banknotes can be taken out from the stacking unit at one time, and the information can be outputted when the banknotes are taken out.

Further, the batch process may include a specific batch process in which a batch quantity of banknotes are stacked, and the batch quantity exceeds a stacking capacity of in the stacking unit, and stacking banknotes in the stacking unit and taking out the banknotes from the stacking unit may be performed a plurality of times in the specific batch process. In the specific batch process, the control unit may determine that the batch process has been completed, and output the information, when a cumulative number of banknotes having been stacked in the stacking unit reaches the batch quantity.

In this configuration, the control unit can output the information for each batch process even when the batch number of banknotes exceed the stacking capacity of the banknotes stacked in the stacking unit. Therefore, in the specific batch process, data management, in particular, the number of banknotes can be strictly managed.

Further, one of the plurality of conditions may be a condition that one transaction is completed in a task which is performed by handling by the handling unit.

In this configuration, the control unit can output the information to the outside when one transaction has been completed. In this case, the control unit can collectively output the information obtained from each of the stacked banknotes, whereby the information is outputted for each transaction, and data of the outputted information, in particular, strict management of the number of banknotes can be advantageously performed.

Further, the plurality of conditions may include at least one of
(1) banknotes are taken out from the stacking unit,
(2) the recognition unit obtains the information,
(3) a user performs an operation for instruction for outputting the information,
(4) the number of banknotes handled by the handling unit reaches a predetermined number of banknotes, and
(5) a predetermined time elapses after the handling has been performed lastly by the handling unit.

In this configuration, in a case where the condition (1) is selected as the condition for outputting the information, the control unit can output, when banknotes are taken out from the stacking unit, the information of the banknotes having been taken out, to the outside. In this case, the control unit can collectively output, when the banknotes are taken out, the information obtained from each of the stacked banknotes. For example, in the above-described specific batch process in which the number of banknotes is set so as to exceed the stacking capacity of the banknotes stacked in the stacking unit, each time banknotes are taken out from the stacking unit, the information about the banknotes having been taken out can be outputted.

Further, in a case where the condition (2) is selected as the condition for outputting the information, the control unit can output the information about the one banknote to the outside each time the information about each banknote is obtained. Therefore, output of the information can be performed at real time in synchronization with obtaining of the information by the recognition unit.

Further, in a case where the condition (3) is selected as the condition for outputting the information, the control unit can output the information when a user makes an instruction for output. Therefore, in, for example, a task, such as depositing or dispensing at a teller window of a bank, which does not include a batch process, information can be outputted for each transaction.

Further, in a case where the condition (4) is selected as the condition for outputting the information, the control unit can output the information at a time based on the number of banknotes which have been handled. Therefore, for example, also in a task, such as the fitness/unfitness sorting in which banknotes are sorted into fit notes and unfit notes, in which the completing of the sorting process is not clearly defined, a time for output can be defined.

Similarly, in a case where the condition (5) is selected as the condition for outputting the information, the control unit can output the information at a time based on a banknote handling time. Therefore, for example, also in a task, such as the fitness/unfitness sorting, in which the completing of the sorting process is not clearly defined, a time for output can be defined.

Further, a task selection unit configured to select a task from among a plurality of predetermined tasks, as a task which is performed by using the handling by the handling unit, may be provided, and the condition selection unit may automatically select a condition from among the plurality of conditions, on the basis of the task selected by the task selection unit.

The “task” includes at least one of, for example, depositing in which banknotes to be deposited are counted by using the banknote handling apparatus, dispensing in which banknotes to be dispensed are counted, a fitness/unfitness sorting in which banknotes are sorted into fit notes and unfit notes, a large-bundle-of-fit/unfit-notes sorting in which banknotes are sorted into fit notes and unfit notes in order to generate a large bundle of fit notes and/or unfit notes, cassette collection in which banknotes having been collected from a cassette are counted, cassette loading in which banknotes to be loaded in a cassette are counted, ATM collection in which banknotes having been collected from an ATM are counted, ATM loading in which banknotes to be loaded in an ATM are counted, and serial number recording in which serial numbers of banknotes are read and recorded.

In this configuration, the information can be outputted at a time appropriate to the task.

Further, on the basis of an operation performed by a user who selects a condition from among the plurality of conditions, the condition selection unit may select the condition.

In this configuration, a time at which the information is outputted can be adjusted as appropriate according to an operation performed by a user.

Further, the control unit may output the information in a predetermined format, and allow the format to be modifiable. Thus, the format can be formed so as to conform to a format required by an information output destination.

As described above, the banknote handling apparatus allows information about banknotes to be outputted at an appropriate time.

### BRIEF DESCRIPTION OF THE DRAWINGS

FIG. 1 is an external view of a banknote handling apparatus;

FIG. 2 schematically illustrates a structure of the banknote handling apparatus;

FIG. 3 is a block diagram illustrating a configuration of the banknote handling apparatus;

FIG. 4 illustrates tasks set for the banknote handling apparatus, and functions set so as to correspond to the tasks, respectively;

FIG. 5 illustrates a task selection screen displayed on a touch panel;

FIG. 6 illustrates a function setting screen which is displayed on the touch panel when fitness/unfitness sorting is selected;

FIG. 7 illustrates a function setting screen which is displayed on the touch panel when a large-bundle-of-fit/unfit-notes sorting is selected;

FIG. 8 illustrates a setting screen that allows the batch number of banknotes to be set by using a pull down menu;

FIG. 9 illustrates a number-of-banknotes selection screen for setting the batch number of banknotes;

FIG. 10 illustrates a correspondence between management units for actual banknotes and units for generating output data files, which is set according to tasks;

FIG. 11 illustrates an output data file and banknote data included in the output data file;

FIG. 12 illustrates a screen displayed on the touch panel in depositing, dispensing, fitness/unfitness sorting, and serial number recording;

FIG. 13 illustrates a screen displayed on the touch panel in cassette collection;

FIG. 14 illustrates a cassette number input screen;

FIG. 15 illustrates a screen displayed on the touch panel in cassette loading;

FIG. 16 illustrates a screen displayed on the touch panel in large-bundle-of-fit/unfit-notes sorting;

FIG. 17 illustrates a screen on which a stacker from which banknotes are to be taken out is indicated to a user in the cassette loading;

FIG. 18 illustrates a screen indicating that the batch number of banknotes have been reached in the cassette loading or ATM loading;

FIG. 19 illustrates an external structure of a banknotes processing machine to which the technique disclosed herein is applicable; and

FIG. 20 illustrates an external structure of a banknote sorting and bundling apparatus to which the technique disclosed herein is applicable.

### DESCRIPTION OF THE PREFERRED EMBODIMENTS

Hereinafter, embodiments will be described in detail with reference to the drawings.

<Schematic Structure of Banknote Handling Apparatus>

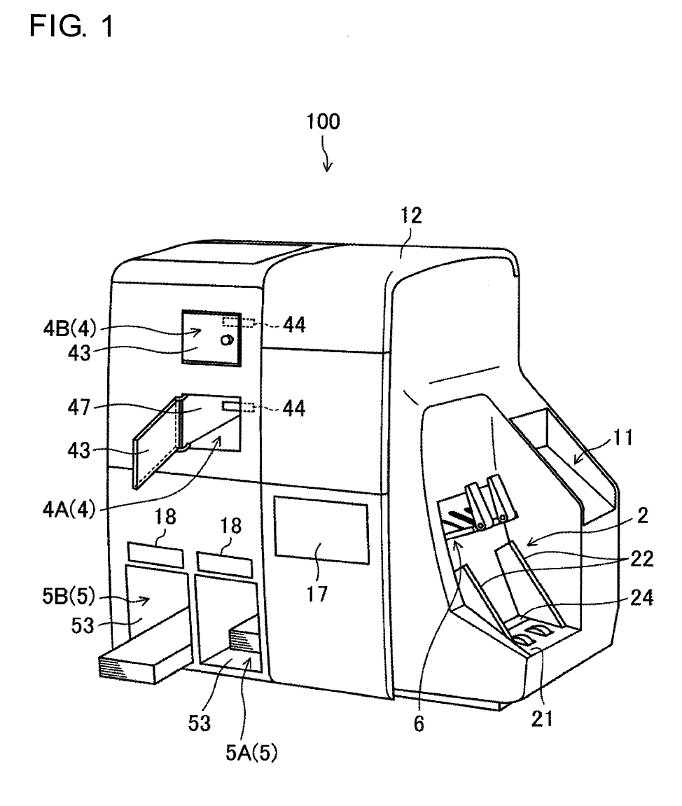

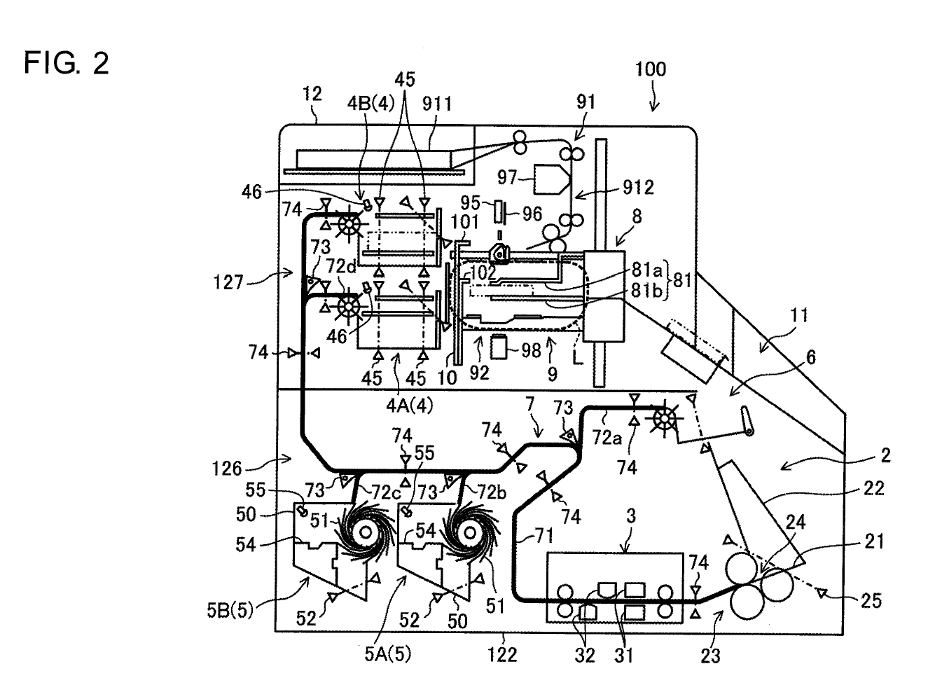

FIG. 1 is an external view of a banknote handling apparatus 100. FIG. 2 schematically illustrates a structure of the banknote handling apparatus 100. The banknote handling apparatus 100 is a banknote processing machine that has a function of taking in loose banknotes, counting the banknotes, sorting the banknotes according to kinds or states of the banknotes, and stacking the banknotes. The banknote handling apparatus 100 also has a function of bundling banknotes.

The banknote handling apparatus 100 is used to perform various tasks in, for example, a cash center or the like. The tasks performed by using the banknote handling apparatus 100 include: fitness/unfitness sorting in which banknotes are sorted into fit notes and unfit notes by the banknote handling apparatus 100; large-bundle-of-fit/unfit-notes sorting in which banknotes are sorted into fit notes and unfit notes and the set number of the fit notes or unfit notes are stacked in order to generate a large bundle of fit notes and/or unfit notes, by the banknote handling apparatus 100; cassette collection in which banknotes collected from a cassette are counted and sorted by the banknote handling apparatus 100; cassette loading in which the set number of banknotes are stacked, as banknotes with which a cassette is loaded, by the banknote handling apparatus 100; ATM collection in which banknotes collected from an ATM are counted and sorted by the banknote handling apparatus 100; ATM loading in which the set number of banknotes are stacked, as banknotes with which an ATM is loaded, by the banknote handling apparatus 100; and serial number recording in which serial numbers of banknotes are read and recorded by the banknote handling apparatus 100. In the cassette loading, an empty cassette is loaded with banknotes, or a cassette having banknotes stored therein is fully loaded with banknotes. Therefore, in the cassette loading, the number of banknotes to be loaded (that is, the batch number of banknotes) is allowed to be optionally set. The same applies to the ATM loading.

Further, the banknote handling apparatus 100 may be installed at, for example, a teller counter of a bank, and used at the teller counter for performing various tasks. The tasks performed at the teller counter include: depositing in which banknotes to be deposited are counted by the banknote handling apparatus 100; and dispensing in which banknotes to be dispensed are counted by the banknote handling apparatus.

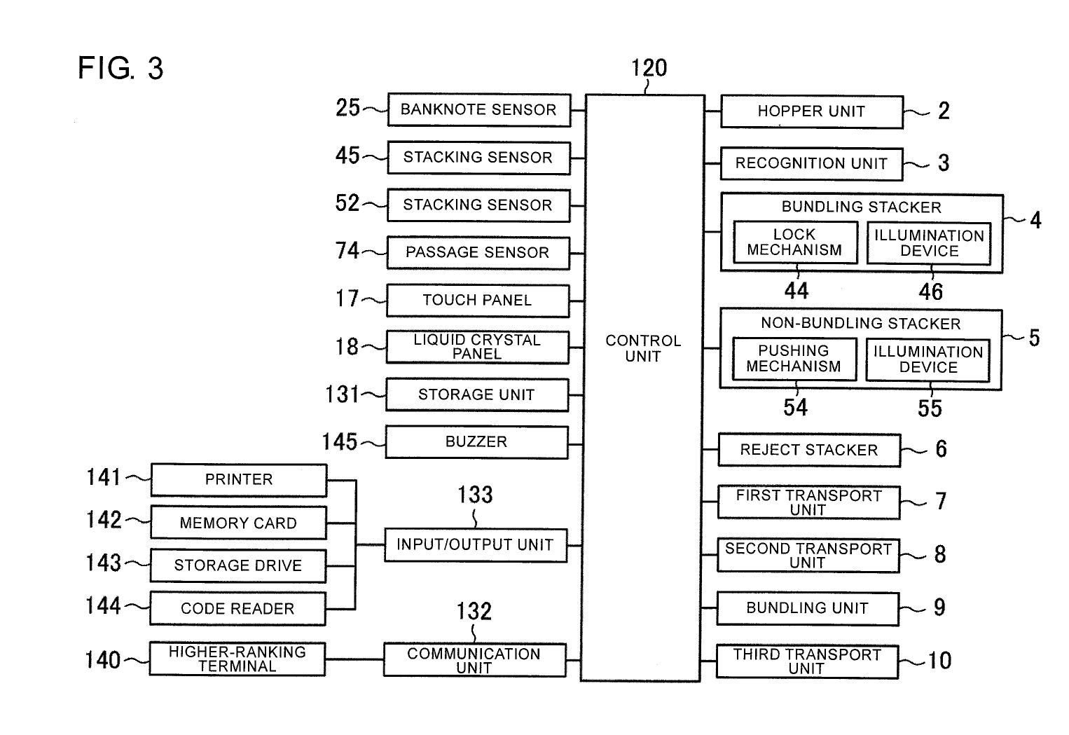

When the banknote handling apparatus 100 is used for performing various tasks described above, the banknote handling apparatus 100 further outputs information (information of banknote) on banknotes that have been handled, as an output data file, to a higher-ranking terminal 140 (see FIG. 3) or the like.

The banknote handling apparatus 100 is used for performing a part of handling in each task, and all necessary handling for performing each task may not be performed by the banknote handling apparatus 100.

Further, the tasks performed by using the banknote handling apparatus 100, are not limited to the tasks described above. The banknote handling apparatus 100 may be used for tasks other than the above-described tasks. Further, the banknote handling apparatus 100 may be used for only a part of these tasks.

The banknote handling apparatus 100 includes: a hopper unit 2, on which banknotes are placed, for taking in the banknotes; a recognition unit 3 that recognizes the banknotes; a bundling stacker 4, as one of stacking units, which stacks banknotes to be bundled; a non-bundling stacker 5, as one of the stacking units, which stacks banknotes to not be bundled; a reject stacker 6 that stacks rejected notes; a first transport unit 7 that transports the banknotes taken in by the hopper unit 2, to the recognition unit 3, the bundling stacker 4, the non-bundling stacker 5, and the reject stacker 6; a second transport unit 8 that transports the banknotes stacked in the bundling stacker 4, to a predetermined position; a bundling unit 9 that bundles the banknotes transported by the second transport unit 8; a third transport unit 10 that transports the banknotes having been bundled (hereinafter, referred to as “bundled banknotes”); a discharge unit 11 that discharges the bundled banknotes; a box-shaped housing 12 that accommodates the recognition unit 3, the bundling stacker 4, the non-bundling stacker 5, the reject stacker 6, the first transport unit 7, the second transport unit 8, the bundling unit 9, and the third transport unit 10.

The housing 12 is divided into a first handling unit 126 that performs handling for recognition and sorting of banknotes, and a second handling unit 127 that performs handling for bundling of banknotes to be bundled. The second handling unit 127 is disposed on the first handling unit 126. The first handling unit 126 includes the hopper unit 2, the recognition unit 3, the non-bundling stacker 5, and the reject stacker 6. The second handling unit 127 includes the bundling stacker 4, the second transport unit 8, the bundling unit 9, and the third transport unit 10. The most part of the first transport unit 7 is included in the first handling unit 126.

The bundling stacker 4 includes two stackers which are a first bundling stacker 4A and a second bundling stacker 4B. Both of the first bundling stacker 4A and the second bundling stacker 4B stack banknotes to be bundled. Setting for banknotes stacked as banknotes to be bundled can be performed as appropriate. The bundling stacker 4 can stack banknotes which are not bundled.

The bundling stacker 4 has a door 43 (see FIG. 1) that opens and closes a first outlet 47 that is open on the side surface of the housing 12. The door 43 is formed of a transparent or translucent material (for example, glass or resin), whereby a portion inward of the door 43 is viewable from the outside.

The door 43 has a lock mechanism 44, which is not shown in detail. When banknotes are stacked in the bundling stacker 4, the lock mechanism 44 is in a locking state so as not to open the door 43. When banknotes which are not bundled are taken out from the bundling stacker 4, the lock mechanism 44 is in an unlocking state. Thus, the door 43 which is prompted by prompting means, automatically opens, to open the first outlet 47.

To the bundling stacker 4, an illumination device (for example, illumination unit including a LED (Light Emitting Diode)) 46 that illuminates the inside of the bundling stacker 4 or a portion near the first outlet 47, is mounted (shown in only FIG. 2). The illumination device 46 illuminates a portion near the bundling stacker 4 when banknotes are taken out from the bundling stacker 4.

The bundling stacker 4 includes a stacking sensor 45 that detects a banknote in the bundling stacker 4. The stacking sensor 45 has a transmitter unit that emits light and a receiver unit that receives light. When light that is emitted from the transmitter unit and is to arrive at the receiver unit, is blocked, the stacking sensor 45 detects a banknote. A stacking sensor 52, a banknote sensor 25, and passage sensors 74 described below have the same structure. The stacking sensor 45 is positioned such that light is blocked by a banknote in the bundling stacker 4. That is, the stacking sensor 45 is allowed to detect that a banknote is in the bundling stacker 4 by the light being blocked. When banknotes are taken out from the bundling stacker 4, the stacking sensor 45 can detect that the banknotes have been taken out from the bundling stacker 4.

The non-bundling stacker 5 includes two stackers which are a first and a second non-bundling stackers 5A and 5B. The first and the second non-bundling stackers 5A and 5B are aligned substantially in the horizontal direction in the first handling unit 126. The non-bundling stacker 5 has a second outlet 53 that is open on the side surface of the housing 12.

The non-bundling stacker 5 includes a pushing mechanism 54 for pushing the stacked banknotes toward the second outlet 53. The pushing mechanism 54 is disposed on the inner side (side opposite to the second outlet 53 side), in the depth direction, of the non-bundling stacker 5, and configured to push the banknotes from the inner side toward the outer side (the second outlet 53 side). Thus, as conceptually shown in FIG. 1, the banknotes project from the second outlet 53.

To the non-bundling stacker 5, an illumination device (for example, an illumination unit including a LED) 55 that illuminates the inside of the non-bundling stacker 5 or a portion near the second outlet 53, is mounted. The illumination device 55 illuminates a portion near the non-bundling stacker 5 when banknotes are taken out from the non-bundling stacker 5.

The non-bundling stacker 5 includes the stacking sensor 52 that detects a banknote in the non-bundling stacker 5. The stacking sensor 52 has the same structure as the stacking sensor 45. The stacking sensor 52 is allowed to detect that a banknote is in the non-bundling stacker 5. Further, when banknotes are taken out from the non-bundling stacker 5, the stacking sensor 52 can detect that the banknotes have been taken out from the non-bundling stacker 5.

The hopper unit 2 includes: a mount 21 on which banknotes are placed; two guide portions 22, 22 that guide the banknotes placed on the mount 21; a taking-in roller 23; an inlet 24 through which the banknotes are taken in; and a banknote sensor 25 that detects a banknote on mount 21. In the present embodiment, banknotes are placed on the hopper unit 2 and taken in such that one long edge of each banknote is a leading end (in the direction parallel to the short edge of the banknote).

The banknote sensor 25 is disposed near the inlet 24. The banknote sensor 25 has the same structure as the stacking sensor 45. The banknote sensor 25 is positioned such that light is blocked by a banknote placed on the mount 21. That is, the banknote sensor 25 is allowed to detect that a banknote is placed on the mount 21 by the light being blocked.

The first transport unit 7 includes a transport belt and the like. The first transport unit 7 has: a main transport path 71; a first to a fourth diverging paths 72a to 72d that diverge from the main transport path 71; diverter mechanisms 73 provided at portions at which the diverging paths diverge from the main transport path 71; and a plurality of passage sensors 74 each of which detects that a banknote passes. The first transport unit 7 transports banknotes such that one long edge of each banknote is a leading end (in the direction parallel to the short edge of the banknote).

The recognition unit 3 is provided upstream of the first diverging path 72a in the main transport path 71. The recognition unit 3 performs, one by one, recognition of the denomination, authentication, and recognition of fitness/unfitness of each of banknotes being transported. Specifically, the recognition unit 3 has a line sensor 31 and a magnetic sensor 32, and obtains characteristics of the banknotes. The recognition unit 3 determines whether or not the characteristics of the banknotes conform to the characteristics of various banknotes which are stored, to perform: recognition of a currency, denomination, year of issue, and version (new/old); authentication; and recognition of fitness/unfitness. The version represents information indicating an edition (version) of a banknote. For example, in the case of a 100-yuan banknote, the version represents information according to which whether the 100-yuan banknote is an old version banknote (the fourth series in 1980, the 1990 edition of the fourth series) or a new version banknote (the fifth series in 2005) is determined.

The recognition unit 3 sorts fitness/unfitness of the banknotes into three levels, that is, ATM fit notes (ATM), Teller fit notes (TLR), and unfit notes (UNFIT). The ATM fit notes are fit notes which are at a level at which banknotes can be used as banknotes dispensed from an ATM. The Teller fit notes are fit notes which are not at a level at which banknotes can be used as banknotes dispensed from an ATM but are at a level at which banknotes can be used as banknotes dispensed at a teller counter of a bank. Fitness/unfitness of banknotes may be sorted into two levels. In this case, the recognition unit 3 sorts fitness/unfitness of banknotes into two levels, that is, fit notes (FIT) that include the ATM fit notes (ATM) and the Teller fit notes (TLR), and unfit notes (UNFIT). In the following description, the level of fitness and unfitness may be referred to as “fitness/unfitness level”.

The recognition unit 3 also obtains image data of banknotes when it recognizes the banknotes. The obtained image data is stored in a storage unit 131 described below. The recognition unit 3 obtains the entire image of the banknote as the image data, and obtains an area including the serial number by cutting the entirety of the image to generate an area image, and further generates a binarized segment image for each character, based on the area image. The recognition unit 3 performs an OCR process on the binarized segment image, and reads the serial number. In the storage unit 131, at least one of the entire image, the area image, and the binarized segment image is stored.

The bundling unit 9 bundles stacked banknotes. The bundling unit 9 forms a tape loop L, and winds back a tape after the banknotes have been transported into the tape loop L, to bundle the banknotes with the tape.

The second transport unit 8 holds the banknotes stacked in the bundling stacker 4, and transports the banknotes into the tape loop L. The second transport unit 8 includes: a holding unit 81 that holds banknotes by an upper arm unit 81a and a lower arm unit 81b; a first horizontal movement mechanism that moves the holding unit 81 horizontally such that one long edge of each banknote is a leading end (in the direction parallel to the short edge of the banknote); a second horizontal movement mechanism that moves the holding unit 81 horizontally such that one short edge of each banknote is a leading end (in the direction parallel to the long edge of the banknote); and an up-down movement mechanism that moves the holding unit 81 in the up-down direction.

The bundling unit 9 has: a tape feeding unit 91 that feeds a tape; a tape loop forming unit 92 that forms the tape loop L with the tape; a heater 95 for joining the tape in a state where the tape is wound around the banknotes; a cutter 96 that cuts the tape at a position where the tape is not wound around the banknotes; a printing unit 97 that performs printing on the tape; and a stamping unit 98 that performs stamping on the tape, as shown in FIG. 2.

The tape feeding unit 91 has: a tape reel 911 in which the tape is wound around a reel; and a tape transport unit 912 that transports the tape drawn from the tape reel 911. The tape transport unit 912 transports the tape along a predetermined transport path. The tape transport unit 912 includes a guide and a plurality of roller pairs, which are not shown.

The tape loop forming unit 92 forms the tape loop L with the tape as indicated by dashed lines in FIG. 2, and winds back the tape after the stacked banknotes have been positioned in the tape loop L, to wind the tape around the banknotes.

The third transport unit 10 transports the bundled banknotes to the discharge unit 11. The third transport unit 10 has an upper holding unit 101, a lower holding unit 102, and a horizontal movement mechanism that horizontally moves the upper holding unit 101 and the lower holding unit 102 such that one long edge of each banknote is a leading end (in the direction parallel to the short edge of the banknote).

On the side surface of the housing 12, as shown in FIG. 1, a touch panel 17 is provided which acts as an operation unit for inputting information to the banknote handling apparatus 100, and acts as a display unit for displaying information from the banknote handling apparatus 100. The touch panel 17 is a human interface portion for an operator who operates the banknote handling apparatus 100.

Further, near the second outlets 53 on the side surface of the housing 12, two display units corresponding to the two second outlets 53, respectively, are provided. In the present embodiment, the display units are, for example, segment-type liquid crystal panels 18. On the liquid crystal panels 18, denominations and versions of banknotes stacked in the non-bundling stacker 5 are displayed as described below. Further, near the first outlets 47 on the side surface of the housing 12, two display units corresponding to the two first outlets 47, respectively, may be provided. These display units may be used as display units on which information on handling performed by the banknote handling apparatus 100 is displayed.

<System Configuration of Banknote Handling Apparatus>

FIG. 3 is a block diagram illustrating a schematic configuration of the banknote handling apparatus 100.

The banknote handling apparatus 100 includes a control unit 120 that is implemented on the basis of, for example, a well-known microcomputer. To the control unit 120, the hopper unit 2, the recognition unit 3, the bundling stacker 4, the non-bundling stacker 5, the reject stacker 6, the first transport unit 7, the second transport unit 8, the bundling unit 9, the third transport unit 10, the touch panel 17, and the liquid crystal panels 18, which are described above, are connected so as to enable signal transmission and reception. Further, to the control unit 120, the banknote sensor 25, the stacking sensor 45, the stacking sensor 52, and the passage sensors 74 are connected, and detection signals therefrom are inputted. Further, the storage unit 131 that stores various information, a communication unit 132 that receives a signal from and outputs a signal to the higher-ranking terminal (for example, server) 140 via a wired or wireless communication line, and an input/output unit 133 are connected to the control unit 120, and input and output of various signals are performed between the storage unit 131, the communication unit 132, and the input/output unit 133, and the control unit 120. The input/output unit 133 is implemented as an input/output port to which an external device of the banknote handling apparatus 100 is connected. To the banknote handling apparatus 100, for example, a printer 141, various memory cards 142 such as an SD card, a storage drive 143 having a storage unit such as a flash memory, and a code reader 144 that reads a bar code and a two-dimensional code, are connected via the input/output unit 133. Further, the banknote handling apparatus 100 includes a buzzer 145 as a warning unit that gives a warning by sound when an operator performs an incorrect operation or the like. The buzzer 145 is actuated by the control unit 120.

The control unit 120 generates a control signal on the basis of, for example, an input signal from the touch panel 17 and detection signals from the various sensors, and outputs the control signal to the hopper unit 2. The hopper unit 2 and the like operate according to the control signal from the control unit 120. The control unit 120 forms a handling unit that performs various handlings including a batch process in the banknote handling apparatus 100.

<Basic Operation of Banknote Handling Apparatus>

Hereinafter, an operation performed by the banknote handling apparatus 100 will be described. The banknote handling apparatus 100 basically causes the recognition unit 3 to, for example, recognize banknotes placed on the hopper unit 2, and divides the banknotes so as to stack the banknotes in the first and the second bundling stackers 4A and 4B and the first and the second non-bundling stackers 5A and 5B according to the recognition result and a predetermined sorting rule, thereby sorting the banknotes. The sorting rule is set by banknotes to be stacked in the stackers 4 and 5 being specified according to a currency, denomination, version (new/old), fitness/unfitness (ATM fit note, Teller fit note, fit note, and unfit note), and the like.

Firstly, an operator places banknotes to be handled, on the hopper unit 2. Subsequently, the operator operates the touch panel 17 to start taking-in of the banknotes. When the banknote sensor 25 detects that the banknotes are placed on the hopper unit 2, the banknote handling apparatus 100 may automatically start taking in the banknotes.

The banknotes placed on the hopper unit 2 are taken in, one by one, through the inlet 24 to the housing 12 by operating of the taking-in roller 23. The banknotes having been taken in thereto, are transported by the first transport unit 7 and pass through the recognition unit 3. The recognition unit 3 obtains information (including at least a denomination, a year of issue, version (new/old) information, fitness/unfitness information, and a serial number) associated with the banknote that is passing, and notifies the control unit 120 of the banknote information.

The control unit 120 determines a destination to which each banknote is transported, that is, the first bundling stacker 4A, the second bundling stacker 4B, the first non-bundling stacker 5A, or the second non-bundling stacker 5B, according to the information associated with the banknote and the predetermined sorting rule. The first transport unit 7 transports the banknote to the first bundling stacker 4A, the second bundling stacker 4B, the first non-bundling stacker 5A, or the second non-bundling stacker 5B, according to the determined destination.

In a case where the sorting rule is such that the same kind of banknotes are stacked in the first bundling stacker 4A and the second bundling stacker 4B, the banknote is transported to one of the two bundling stackers 4. In a case where the number of the banknotes stacked in the one of the bundling stackers 4 reaches a predetermined number of banknotes (for example, 100 banknotes), the banknotes subsequent thereto are transported to the other of the bundling stackers 4. Also in a case where the sorting rule is such that the same kind of banknotes are stacked in the first non-bundling stacker 5A and the second non-bundling stacker 5B, the banknotes are handled in the same manner as described for the bundling stacker 4. When the banknote is a rejected note, the control unit 120 determines the reject stacker 6 as the transport destination. Examples of the rejected note include an undesignated banknote, an abnormal banknote, an abnormally transported banknote, and a counterfeit note. The undesignated banknote is a banknote for which the destination is not set as any of the first bundling stacker 4A, the second bundling stacker 4B, the first non-bundling stacker 5A, and the second non-bundling stacker 5B although the banknotes is determined as a normal banknote. The abnormal banknote is a banknote that cannot be determined as a banknote according to the information obtained by the recognition unit 3. The abnormally transported banknote is a banknote for which the information on the banknote cannot be normally obtained due to abnormal transport such as skew or chaining. The counterfeit note is a banknote that is determined as being likely to be a counterfeit note, as a result of comparison between the information on the banknote, and previously stored counterfeit note information.

The banknote handling apparatus 100 can perform a batch process for stacking, while sorting banknotes, a predetermined number (that is, the set batch number) of banknotes in the bundling stacker 4 or the non-bundling stacker 5. In the batch process, when the set batch number of banknotes have been stacked in the bundling stacker 4 or the non-bundling stacker 5, banknotes are prohibited from being stacked anew in the stacker. When the batch number of banknotes are stacked in the bundling stacker 4, the lock mechanism 44 enters an unlocking state, to open the door 43. Further, the illumination device 46 illuminates the inside of the bundling stacker 4 from which the banknotes are to be taken out, or a portion near the first outlet 47 through which the banknotes are to be taken out. An operator is allowed to take out the banknotes through the first outlet 47 from the bundling stacker 4. Further, when the batch number of banknotes are stacked in the non-bundling stacker 5, the pushing mechanism 54 pushes the banknotes. Further, the illumination device 55 illuminates the inside of the non-bundling stacker 5 from which the banknotes are to be taken out or a portion near the second outlet 53 through which the banknotes are to be taken out. The operator takes out the banknotes through the second outlet 53 from the non-bundling stacker 5. The stacking sensor 45 and the stacking sensor 52 detect that taking-out of the banknotes has been completed. After the taking-out thereof has been completed, stacking banknotes in the stacker anew is automatically or manually restarted.

Further, in a case where the banknotes stacked in the bundling stacker 4 are bundled, when the set number of banknotes to be bundled have been stacked in the bundling stacker 4, the control unit 120 controls the second transport unit 8 to hold the banknotes in the first bundling stacker 4A by means of the holding unit 81, and transport the banknotes to the bundling unit 9. Thereafter, the control unit 120 controls the bundling unit 9 to bundle the banknotes with a tape. The bundled banknotes are discharged through the discharge unit 11 by the third transport unit 10.

<Task Using Banknote Handling Apparatus>

As described above, the banknote handling apparatus 100 is used to perform a part of handling in each of various tasks such as the depositing, the dispensing, the fitness/unfitness sorting, the large-bundle-of-fit/unfit-notes sorting, the cassette collection, the cassette loading, the ATM collection, the ATM loading, and the serial number recording. The banknote handling apparatus 100 is a general-purpose banknote processing machine that has various functions. In a case where the banknote handling apparatus 100 is used for the tasks described above, the corresponding functions need to be individually set.

Specifically, the banknote handling apparatus 100 has at least the following functions.

(1) Function of bundling banknotes (bundling function)

(2) Function of transporting banknotes to a predetermined destination according to a sorting rule (transport category setting function)

(3) Specific batch process function, of stacking banknotes, in which the number of the banknotes exceeds the maximum number of banknotes which can be stacked in the bundling stacker 4 or the non-bundling stacker 5, according to fitness/unfitness levels (fitness/unfitness batch function)

(4) Function of causing operation of the banknote handling apparatus 100 to be manually restarted after banknotes have been taken out from the bundling stacker 4 or the non-bundling stacker 5 when the fitness/unfitness batch process has been completed (that is, feeding stop function of stopping feeding banknotes when the fitness/unfitness batch process has been completed), and

(5) Function of printing a label by means of the printer 141 such that information associated with banknotes for which handling has been performed by the banknote handling apparatus 100 is printed on the label (label printing function).

The banknote handling apparatus 100 also has a normal batch process function, of stacking banknotes, in which the number of the banknotes is less than or equal to the maximum number of banknotes which can be stacked in the bundling stacker 4 or the non-bundling stacker 5, in addition to the functions (1) to (5) described above.

The functions of the banknote handling apparatus 100 are not limited to the above functions, and the banknote handling apparatus 100 may have a function different from the above functions. Further, the banknote handling apparatus 100 may have only some the above functions.

The fitness/unfitness batch function and the feeding stop function will be described in detail. As described above, the fitness/unfitness batch function is a function of performing a batch process (specific batch process) in which the batch number of banknotes exceed the stacking capacity of banknotes stacked in the bundling stacker 4, or exceed the stacking capacity of banknotes stacked in the non-bundling stacker 5. For example, in the large-bundle-of-fit/unfit-notes sorting, in a case where the number of banknotes in a large bundle is set as 1000, the batch number is 1000. Further, in the cassette loading, in a case where the maximum number of banknotes which can be stored in a cassette is 2000, when banknotes are loaded in an empty cassette, the batch number is, for example, 2000. The stacking capacity of banknotes stacked in each of the bundling stacker 4 and the non-bundling stacker 5 is set as 500 banknotes or less in many cases. Therefore, the maximum number of banknotes which can be stored in a large bundle or a cassette may exceed the stacking capacity of banknotes stacked in the bundling stacker 4 or the non-bundling stacker 5. Further, in the ATM loading, in a case where the number of banknotes to be loaded in an ATM is 2500, the batch number is, for example, 2500.

In the large-bundle-of-fit/unfit-notes sorting, in order to perform the specific batch process in which the number of banknotes exceed the stacking capacity of banknotes stacked in the bundling stacker 4 or the non-bundling stacker 5, for example, the normal batch process in which the batch number is 100 (the batch number is less than or equal to the stacking capacity of banknotes stacked in the bundling stacker 4 or the non-bundling stacker 5) is performed ten times. Specifically, when 100 banknotes have been stacked in the bundling stacker 4 or the non-bundling stacker 5, the banknote handling apparatus 100 prohibits banknotes from being stacked anew in the stacker until an operator takes out the 100 banknotes from the bundling stacker 4 or the non-bundling stacker 5. After the operator has taken out the banknotes from the stacker, the banknote handling apparatus 100 restarts stacking banknotes anew in the stacker, to stack again 100 banknotes in the bundling stacker 4 or the non-bundling stacker 5. The banknote handling apparatus 100 waits until the operator takes out the banknotes. Thus, when the fitness/unfitness batch function is performed, each time 100 banknotes are stacked in the bundling stacker 4 or the non-bundling stacker 5, the operator takes out the banknotes therefrom.

In the large-bundle-of-fit/unfit-notes sorting, when 1000 fit notes have been sorted (that is, the batch has been obtained), a label to be attached to the large bundle is printed, and the label is attached to the large bundle. In the cassette loading, when, for example, 2000 ATM fit notes have been sorted, a cassette which has been loaded with the banknotes is placed at a predetermined position, and a cassette to be subsequently loaded is prepared in hand.

Thus, in the large-bundle-of-fit/unfit-notes sorting, the cassette loading, and the ATM loading, taking-out of banknotes is repeated, and the specific batch process for 1000 banknotes or 2000 banknotes is completed in the course of the process. In a case where the large bundle is sequentially generated or in a case where loading of a cassette is sequentially performed, an operator may not easily know when the specific batch process has been completed. Further, when the specific batch has been obtained, the operator needs to perform an auxiliary task such as attaching of the label or preparing of the cassette. These may cause the operator to make a mistake.

Therefore, the banknote handling apparatus 100 has the feeding stop function. The feeding stop function is a function of stopping the feeding by the banknote handling apparatus 100 in the large-bundle-of-fit/unfit-notes sorting, the cassette loading, and the ATM loading under the condition that the specific batch process has been completed, as described above. Further, after the specific batch process has been completed, even when an operator has taken out banknotes from the bundling stacker 4 or the non-bundling stacker 5, the feeding by the banknote handling apparatus 100 preferably remains stopped. Thus, the operator is allowed to assuredly recognize completion of one fitness/unfitness batch process. After, for example, the operator has performed the auxiliary task, the operator performs a predetermined operation (for example, selects a restart button provided on the touch panel 17) on the banknote handling apparatus 100, whereby the feeding by the banknote handling apparatus 100 can be restarted. Thus, a mistake can be avoided. The feeding stop function is effective also when bundled banknotes generated by the bundling unit 9 are discharged from the discharge unit 11.

Meanwhile, in a case where, for example, a plurality of operators perform one task in cooperation with each other, even if stopping of the feeding by the banknote handling apparatus 100 according to the specific batch process having been completed, is not performed, the task can be correctly performed. Therefore, the banknote handling apparatus 100 is configured so as to allow an operator to selectively set the feeding stop function as ON or OFF. When the feeding stop function is set as ON (enabled), the feeding by the banknote handling apparatus 100 is stopped at a time when the specific batch is obtained, and even when the banknotes have been taken out from the bundling stacker 4 or the non-bundling stacker 5, the feeding by the banknote handling apparatus 100 remains stopped, as described above. The operation by the banknote handling apparatus 100 is restarted according to an operation performed by the operator. Meanwhile, in a case where the feeding stop function is set as OFF (disabled), when the specific batch process has been completed, if banknotes can be stacked in a stacker other than the bundling stacker 4 or the non-bundling stacker 5 which is used for the specific batch process, the feeding by the banknote handling apparatus 100 is not stopped. Further, when banknotes are taken out from the bundling stacker 4 or the non-bundling stacker 5 which is used for the specific batch process, the stacking sensor 45 or 52 detects the taking-out, and stacking banknotes in the stacker is automatically restarted.

Also in the normal batch process as well as the specific batch process such as the fitness/unfitness batch function, the feeding stop function may be set as ON.

On the label printed in the label printing function, for example, bank information, apparatus information, banknote information, and a two-dimensional code in which such information is stored, are printed. Information other than such information may be printed on the label. Further, only a part of such information may be printed on the label.

<Setting of Operation of Banknote Handling Apparatus>

The functions (1) to (5) are not always necessary for performing the above tasks, and some of the functions may be unnecessary depending on the tasks. For example, the fitness/unfitness batch function is unnecessary in the fitness/unfitness sorting, whereas the fitness/unfitness batch function is necessary in the large-bundle-of-fit/unfit-notes sorting. Therefore, when the banknote handling apparatus 100 is used for performing each task, necessary functions need to be set as ON and unnecessary functions need to be set as OFF.

The banknote handling apparatus 100 is configured to be able to select a task to be performed, from among the above tasks, so as to allow an operator to easily perform setting of the functions. When the operator selects a task, unnecessary functions among the above functions (1) to (5) are automatically set as OFF, and an operator is allowed to set only each of the other functions as ON or OFF, and to perform, for functions having been set as ON, specific setting for performing the functions (that is, a first mode).

The banknote handling apparatus 100 also has, in addition to the operation in the first mode, a mode (that is, a second mode) in which the functions (1) to (5) are set one by one so as to be ON or OFF, and, for functions having been set as ON, the specific setting (for example, the batch number or the like in the case of the fitness/unfitness batch function) for the functions is manually performed.

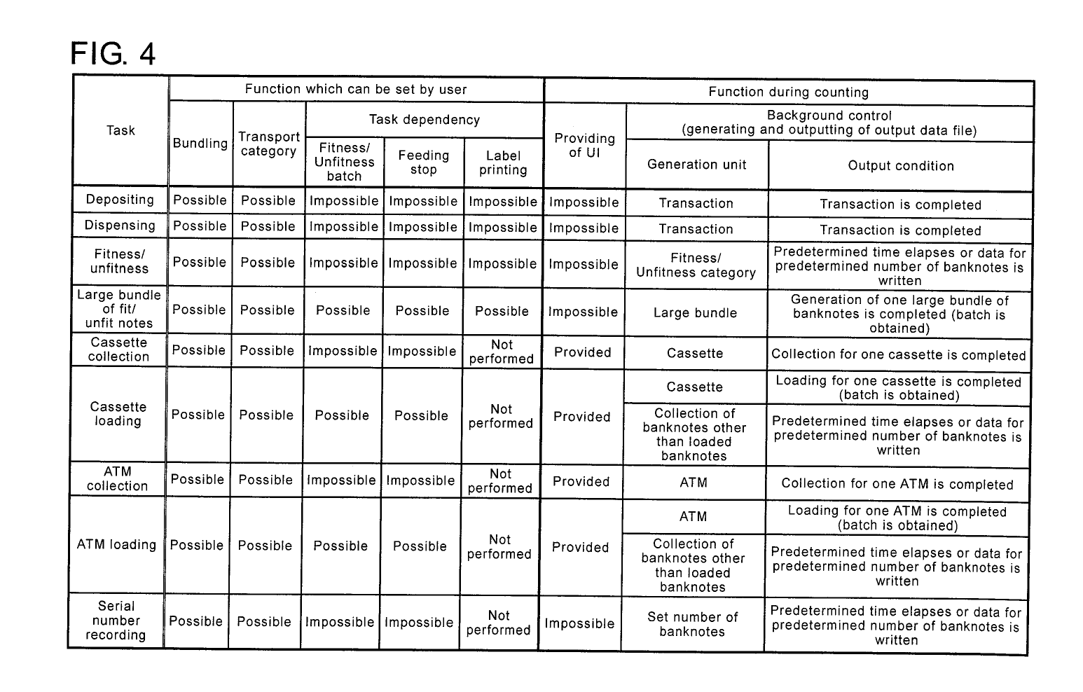

FIG. 4 illustrates correspondence between tasks that can be selected in the banknote handling apparatus 100, and functions that are set in the banknote handling apparatus 100. The correspondence illustrated in FIG. 4 is stored in the banknote handling apparatus 100, and the control unit 120 causes the banknote handling apparatus 100 to operate according to the correspondence.

In FIG. 4, the functions represented as “possible” are functions that can be set when the task is selected. The functions represented as “impossible” are functions that cannot be set when the task is selected. That is, a function unnecessary for performing the task is automatically made OFF according to the task being selected by an operator.

Specifically, the bundling function can be set as ON for all the tasks of the depositing, the dispensing, the fitness/unfitness sorting, the large-bundle-of-fit/unfit-notes sorting, the cassette collection, the cassette loading, the ATM collection, the ATM loading, and the serial number recording. Further, the transport category setting function can be also set as ON for all the tasks.

The fitness/unfitness batch function can be set as ON for only the large-bundle-of-fit/unfit-notes sorting, the cassette loading, and the ATM loading, and cannot be set for the other tasks (that is, set as OFF). Further, similarly to the fitness/unfitness batch function, the feeding stop function can be also set as ON for only the large-bundle-of-fit/unfit-notes sorting, the cassette loading, and the ATM loading, and cannot be set for the other tasks (that is, set as OFF). The label printing function can be set as ON for only the large-bundle-of-fit/unfit-notes sorting. In the example described herein, the specifications are such that the label printing function is not performed for the cassette collection, the cassette loading, the ATM collection, the ATM loading, and the serial number recording. That is, in each of the cassette collection, the cassette loading, the ATM collection, the ATM loading, and the serial number recording, the label printing may be set so as to be performed. In the example described herein, the label printing function cannot be set for the depositing, the dispensing, and the fitness/unfitness sorting since the label printing function is regarded as being unnecessary for these tasks. However, also in these tasks, the label printing function may be set as ON and label printing may be performed.

Next, setting of the functions in the case of a task being selected will be specifically described with reference to an exemplary screen displayed on the touch panel 17 of the banknote handling apparatus 100. Screens S1 to S9 used for the following description are exemplary ones, and the screen configuration may be changed as appropriate.

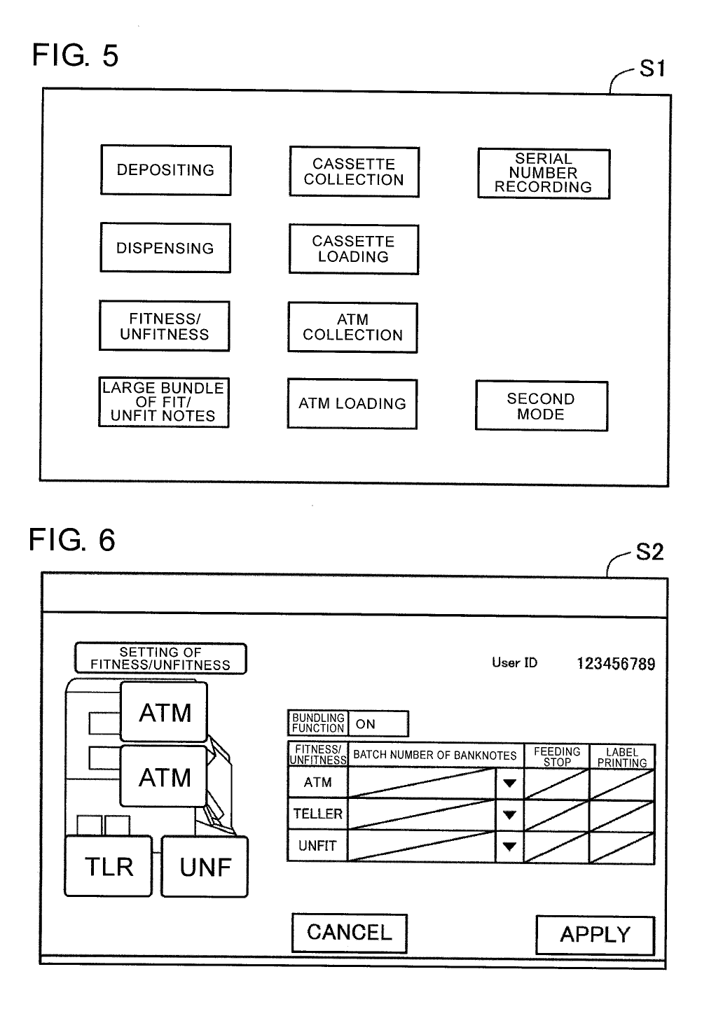

Firstly, FIG. 5 shows an example of an initial screen S1. The initial screen S1 is displayed on the touch panel 17 after the banknote handling apparatus 100 is actuated and log-in is performed. The initial screen S1 includes buttons for selecting the tasks. By the initial screen S1, a task selection unit is implemented. The initial screen S1 includes task selection buttons such as a depositing selection button, a dispensing selection button, a fitness/unfitness sorting selection button, a large-bundle-of-fit/unfit-notes sorting selection button, a cassette collection selection button, a cassette loading selection button, an ATM collection selection button, an ATM loading selection button, and a serial number recording selection button. The initial screen S1 also includes a second mode selection button. The second mode selection button is used not for selecting a task, but for a mode in which an operator sets, one by one, the functions so as to be ON or OFF, and performs, for a function having been set as ON, specific setting for the function, as described above. The operator selects one of the task selection buttons on the initial screen S1, whereby a task to be performed is selected. When the task selection button is selected, the banknote handling apparatus 100 operates in the first mode. Meanwhile, when the second mode selection button is selected, the banknote handling apparatus 100 operates in the second mode. A button can be deleted from or added to the buttons displayed on the initial screen S1 as appropriate according to tasks using the banknote handling apparatus 100.

FIG. 6 illustrates an example of a function setting screen S2 which is displayed on the touch panel 17 when the fitness/unfitness sorting selection button is selected on the initial screen S1. The function setting screen S2 includes, on the left side thereof, items (that is, items for setting transport categories) for setting banknotes to be stacked in the first and the second bundling stackers 4A and 4B and the first and the second non-bundling stackers 5A and 5B. As shown in FIG. 4, in the fitness/unfitness sorting, the transport category setting function can be set as ON, whereby the setting thereof can be performed on the function setting screen S2. In the function setting screen S2 shown in FIG. 6, the items for setting banknotes to be stacked in the first and the second bundling stackers 4A and 4B and the first and the second non-bundling stackers 5A and 5B are arranged so as to correspond to arrangement of the first and the second bundling stackers 4A and 4B and the first and the second non-bundling stackers 5A and 5B in the banknote handling apparatus 100. In the example shown in FIG. 6, the setting is such that ATM fit notes (ATM) are stacked in the first and the second bundling stackers 4A and 4B, unfit notes (UNF) are stacked in the first non-bundling stacker 5A, and Teller fit notes (TLR) are stacked in the second non-bundling stacker 5B.

The function setting screen S2 also includes, on the right side thereof, an item for setting the bundling function as ON or OFF, an item for setting the batch number in the fitness/unfitness batch function, an item for setting the feeding stop function, and an item for setting the label printing function. Among the items, in the fitness/unfitness sorting, the bundling function can be set as ON, whereas the fitness/unfitness batch function, the feeding stop function, and the label printing function cannot be set (see FIG. 4). Therefore, on the function setting screen S2, the item for setting the batch number, the item for setting the feeding stop function, and the item for setting the label printing function are all disabled (in the illustrated example, diagonal lines are drawn.).

An operator performs setting for the items that are enabled on the function setting screen S2. Thereafter, an application (APPLY) button is selected, whereby function setting for the selected task (in this case, the fitness/unfitness sorting) is completed.

Further, on the upper-right portion of the screen on the function setting screen S2, an ID of an operator who has performed the log-in is displayed.

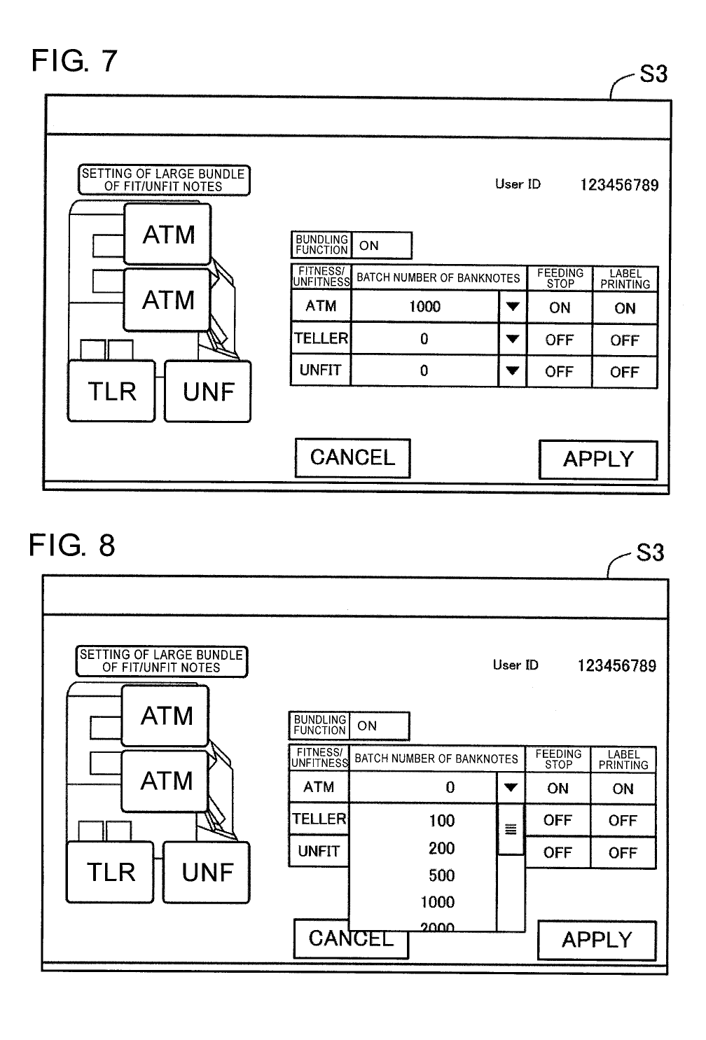

FIG. 7 illustrates an example of a function setting screen S3 which is displayed on the touch panel 17 when the large-bundle-of-fit/unfit-notes sorting selection button is selected on the initial screen S1. The function setting screen S3 has the same configuration as the function setting screen S2 shown in FIG. 6. Also in the large-bundle-of-fit/unfit-notes sorting, the transport category setting function and the bundling function can be set as ON, and the setting thereof can be performed.

Further, in the large-bundle-of-fit/unfit-notes sorting, unlike the fitness/unfitness sorting, the fitness/unfitness batch function, the feeding stop function, and the label printing function can be set as ON (see FIG. 4). Therefore, on the function setting screen S3, these items can be set.

In the example shown in FIG. 7, the fitness/unfitness of banknotes are sorted into three levels. Therefore, in the item for setting the batch number, the batch number can be set for each of the ATM fit note (ATM), the Teller fit note (TLR), and the unfit note (UNF). In the example shown in FIG. 7, the batch number is set as 1000 for the ATM fit note, and the batch number is not set for each of the Teller fit note and the unfit note (that is, set as 0). In a case where the fitness/unfitness of banknotes is sorted into two levels, the batch number is set for each of the fit note (FIT) and the unfit note (UNF) in the items for setting the batch number.

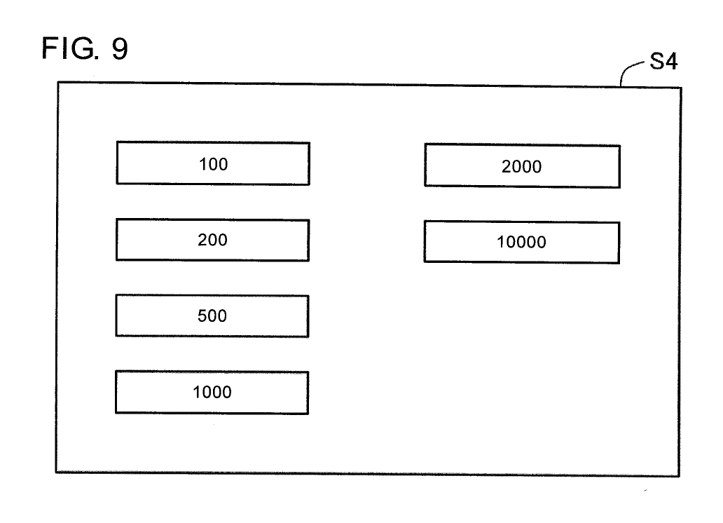

On the function setting screen S3, when the batch number is set, a pull down menu is displayed as shown in FIG. 8. An operator selects a desired batch number from the pull down menu, whereby the batch number can be set. The pull down menu allows labor and time for setting the batch number by an operator to be reduced. Instead of the pull down menu, as shown in FIG. 9, a number-of-banknotes selection screen S4 that includes candidates for the batch number may be displayed on the touch panel 17. Also in this configuration, labor and time for setting the batch number by an operator can be reduced. The contents displayed in the pull down menu or on the-number-of-banknotes selection screen S4 can be customized by an operator. For example, an item to be selected in the pull down menu, or a candidate for the batch number to be displayed on the number-of-banknotes selection screen S4 can be added or deleted, or the contents can be changed. Instead of or in addition to the pull down menu or the number-of-banknotes selection screen S4 being displayed, numeric characters such as “100” or “1000” may be manually inputted by an operator, whereby the batch number can be set.

In the example shown in FIG. 7, the feeding stop function is set as ON for the ATM fit note (that is, the feeding by the banknote handling apparatus 100 is stopped after the specific batch for the ATM fit notes has been obtained. Further, the feeding by the banknote handling apparatus 100 is not restarted until an operator performs a restart operation (for example, the operator selects a button provided on the touch panel 17) after banknotes have been taken out from the bundling stacker 4 or the non-bundling stacker 5), and is set as OFF for the other notes. Specifically, at a time when the cumulative number of the ATM fit notes stacked in the first and the second bundling stackers 4A and 4B has reached 1000, the feeding by the banknote handling apparatus 100 is stopped. The feeding stop function is a function based on the fitness/unfitness batch process being performed. Therefore, on the function setting screen S3, setting of the feeding stop function may be disabled (that is, the feeding stop function remains OFF) when the batch number is not set, and setting of the feeding stop function may be enabled when the batch number is set.

Further, in the example shown in FIG. 7, the label printing function is set as ON for the ATM fit note, and the label printing function is set as OFF for the other notes.

An operator performs setting of the items which can be set, on the function setting screen S3. Thereafter, application (APPLY) button is selected, whereby function setting for the selected task (in this case, the large-bundle-of-fit/unfit-notes sorting) is completed.

Thus, when one of the task selection buttons is selected on the initial screen S1, the banknote handling apparatus 100 enters the first mode, and the control unit 120 causes the touch panel 17 to display the function setting screen S2 or S3 corresponding to the selected task, as illustrated in FIG. 6 or FIG. 7. The operator performs setting for only the items that can be set, on the function setting screen S2 or S3, whereby setting of the banknote handling apparatus 100 can be used for the selected task, and the banknote handling apparatus 100 operates so as to be usable in the selected task. On the function setting screens S2, S3, according to the selected task, only a function that can be necessary for the task can be set as ON, and a function unnecessary for the task cannot be set as described above, whereby labor and time for setting by an operator can be reduced, and efficiency for the task is improved.

Meanwhile, when the second mode selection button is selected on the initial screen S1, the banknote handling apparatus 100 enters the second mode, and the function setting screen that allows all the functions of the banknote handling apparatus 100 to be set, is displayed on the touch panel 17, (which is not shown). On the setting screen, an operator sets the functions one by one as ON or OFF, and performs, for the functions having been set as ON, specific setting for the functions. Also in the second mode, the banknote handling apparatus 100 can be used for the above tasks when necessary setting is performed.

In each of the first mode and the second mode, when the application button is selected on the function setting screen, the banknote handling apparatus 100 shifts to a stand-by state in which the operation can be performed. As described above, when banknotes are placed on the hopper unit 2, and a start button on the screen displayed on the touch panel 17 is selected during the operation, the banknote handling apparatus 100 operates according to the set contents.

In the above configuration, in the first mode, an operator performs setting for the functions necessary for the task on the function setting screens S3, S4. Unlike this, default functions corresponding to each task may be preset, and when one of the tasks is selected on the initial screen S1, the default functions may be automatically set without displaying the function setting screens S2, S3 (that is, the functions necessary for the task are set as ON, and unnecessary functions are set as OFF), and the banknote handling apparatus 100 may shift to a stand-by state. Thus, labor and time for setting by a user can be greatly reduced. In the configuration in which the default functions are set, an operator may be allowed to change the function setting as necessary.

<Description of Output Data File>

The banknote handling apparatus 100 has a function of generating an output data file which includes the banknote information read by the recognition unit 3, and outputting the generated output data file to the outside, when the banknote handling apparatus 100 is used for the above task. The output data file is generated by the control unit 120. By the control unit 120, a file generating unit is implemented. The output data file includes association data (association information) associated with an actual banknote in order to enable, for example, tracing of the banknote. For example, when the serial number of a banknote is used as a search key, and the banknote is specified in the output data file, a customer associated with the banknote, a cassette in which the banknote is loaded, an ATM in which the banknote is loaded, or the like can be traced on the basis of the association data.

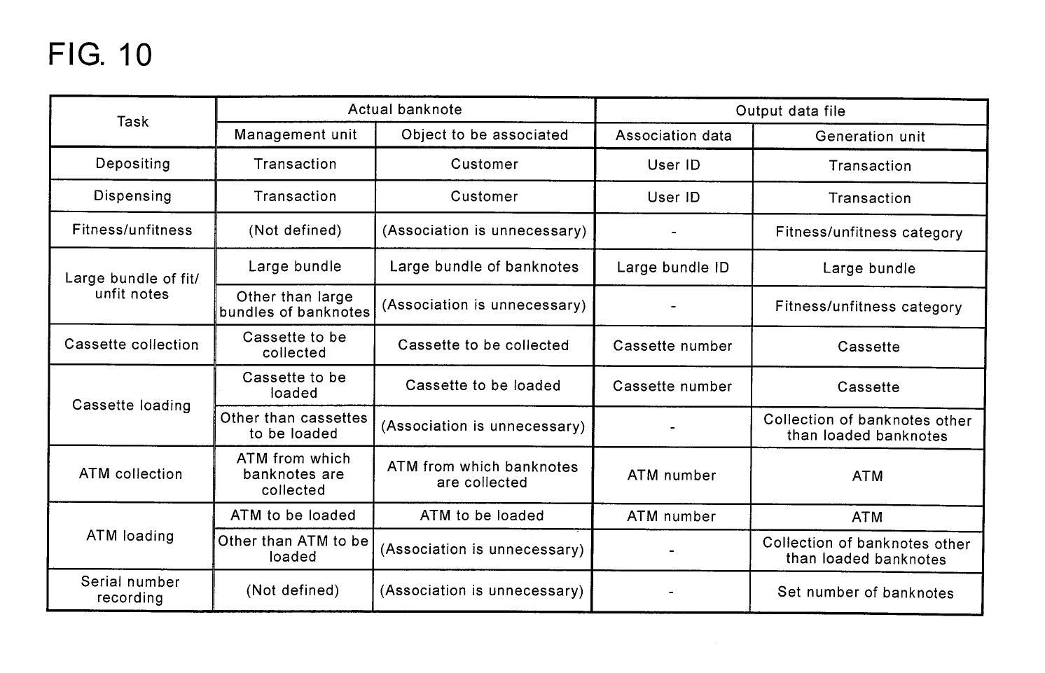

FIG. 10 shows a management unit for actual banknotes in each of the above tasks. The output data file is generated by the banknote handling apparatus 100 so as to correspond to the management unit for the actual banknotes. Hereinafter, the management unit in each task, the generated output data file for each task, and the association data included in the output data file will be described.

In both depositing and dispensing, a transaction is a management unit for actual banknotes. A generating unit for generating an output data file is also a transaction in depositing and dispensing. That is, in each of depositing and dispensing, actual banknotes handled by the banknote handling apparatus 100 are managed collectively for one transaction, and information of all the banknotes handled by the banknote handling apparatus 100 is collected into one output data file for the one transaction. Further, in each of depositing and dispensing, a subject to be associated with the actual banknotes is a customer in the transaction, and the association data to be included in the output data file is an ID (user ID) for specifying the customer.

In the fitness/unfitness sorting, a management unit for actual banknotes is not defined. A generating unit for generating an output data file in the fitness/unfitness sorting is a fitness/unfitness category. That is, in the fitness/unfitness sorting, in a case where, for example, the fitness/unfitness of the banknotes is sorted into two levels, information of fit notes in the banknotes handled by the banknote handling apparatus 100 in the task is collected into one output data file, and information of unfit notes therein is collected into another output data file. Similarly, in a case where the fitness/unfitness of banknotes is sorted into three levels, information of ATM fit notes is collected into one output data file, information of Teller fit notes is collected into another output data file, and information of unfit notes is collected into the other output data file. Further, in the fitness/unfitness sorting, association is unnecessary, and each output data file does not include the association data.

In the large-bundle-of-fit/unfit-notes sorting, a management unit for banknotes, among actual banknotes, sorted into large bundle units is a large bundle. Further, in the large-bundle-of-fit/unfit-notes sorting, a unit for generating an output data file for such banknotes is the large bundle. Therefore, in the large-bundle-of-fit/unfit-notes sorting, banknotes, among actual banknotes, sorted into large bundle units are managed in the large bundle units of large bundles generated by fit notes or unfit notes, and information of all the banknotes included in the generated large bundle is collected into one output data file for each large bundle having been generated. In the large-bundle-of-fit/unfit-notes sorting, an object to be associated with the actual banknotes is a large bundle of banknotes, and the association data is a large bundle ID assigned to the large bundle.

Further, in the large-bundle-of-fit/unfit-notes sorting, banknotes (for example, remaining banknotes that are sorted as fit notes as a result of recognition by the banknote handling apparatus 100, but are not sufficient to be collected as the large bundle unit) which are not sorted into the large bundle units are separately managed. That is, a management unit for the banknotes, among the actual banknotes, which are not sorted into the large bundle units is “other than the large bundles of banknotes”. Further, a generating unit for generating an output data file for such banknotes is a fitness/unfitness category, similarly to the fitness/unfitness sorting.

Therefore, in the large-bundle-of-fit/unfit-notes sorting, the actual banknotes are managed in the large bundle units, and information of the banknotes sorted as each large bundle unit is collected into one file. Meanwhile, actual banknotes which are handled by the banknote handling apparatus 100 and are not sorted into the large bundle units, are separately managed, and an output data file for the banknotes that are not sorted into the large bundle units, is separately generated. In the large-bundle-of-fit/unfit-notes sorting, association is unnecessary for the banknotes which are not sorted into the large bundle units, and the output data file does not include the association data.

In the cassette collection, a management unit for the actual banknotes is a cassette to be collected, and a generating unit for generating an output data file is the cassette. In the cassette collection, the actual banknotes are managed in units of cassettes to be collected, and information of all the banknotes collected from each cassette is collected into one output data file. In the cassette collection, an object to be associated is a cassette to be collected, and the association data is a cassette number for specifying the cassette.

Further, similarly to the cassette collection, in the ATM collection, actual banknotes are managed in units of ATMs from which banknotes are collected, and information of all the banknotes collected from each ATM is collected into one output data file. In the ATM collection, an object to be associated is an ATM from which banknotes are collected, and the association data is an ATM number for specifying the ATM.

In the cassette loading, a management unit for actual banknotes corresponds to a cassette to be loaded. A generating unit for generating an output data file corresponds to the cassette. Further, in the cassette loading, banknotes (for example, banknotes recognized by the banknote handling apparatus 100 as being not ATM fit notes) which cannot be loaded in the cassettes for various reasons are separately managed, and an output data file for the banknotes (other than loaded banknotes) which cannot be loaded therein is separately generated (“collection of banknotes other than loaded banknotes”). Therefore, in the cassette loading, actual banknotes are managed in loaded cassette units, and actual banknotes which have been handled by the banknote handling apparatus 100 but cannot be loaded in the cassettes are separately managed, and information of the banknotes loaded in each cassette is collected into one file, and an output data file for the banknotes which are not loaded in the cassettes is separately generated. In the cassette loading, an object to be associated is a cassette to be loaded, and the association data is a cassette number for specifying the cassette. Further, in the cassette loading, association is unnecessary for the banknotes which are not loaded in the cassettes, and the output data file does not include the association data.

Similarly to the cassette loading, in the ATM loading, actual banknotes are managed in ATM units, and actual banknotes which have been handled by the banknote handling apparatus 100 but cannot be loaded in the ATMs are separately managed. Information of the banknotes loaded in each ATM is collected into one output data file, and an output data file for the banknotes which are not loaded in the ATMs is separately generated. In the ATM loading, an object to be associated is an ATM to be loaded, and the association data is an ATM number for specifying the ATM. In the ATM loading, association is unnecessary for the banknotes which are not loaded in the ATMs, and the output data file does not include the association data.

In the serial number recording, a unit for recording actual banknotes is not defined. In the serial number recording, one output data file for the banknotes is generated in units of the set number of banknotes. Further, in the serial number recording, association is unnecessary, and the output data file does not include the association data.

When the banknote handling apparatus 100 operates in the first mode, the unit for generating the output data file and the association data to be included in the output data file are automatically set so as to correspond to the selected task (see FIG. 4). Meanwhile, when the banknote handling apparatus 100 operates in the second mode, an operator manually sets the unit for generating the output data file and the association data to be included in the output data file.

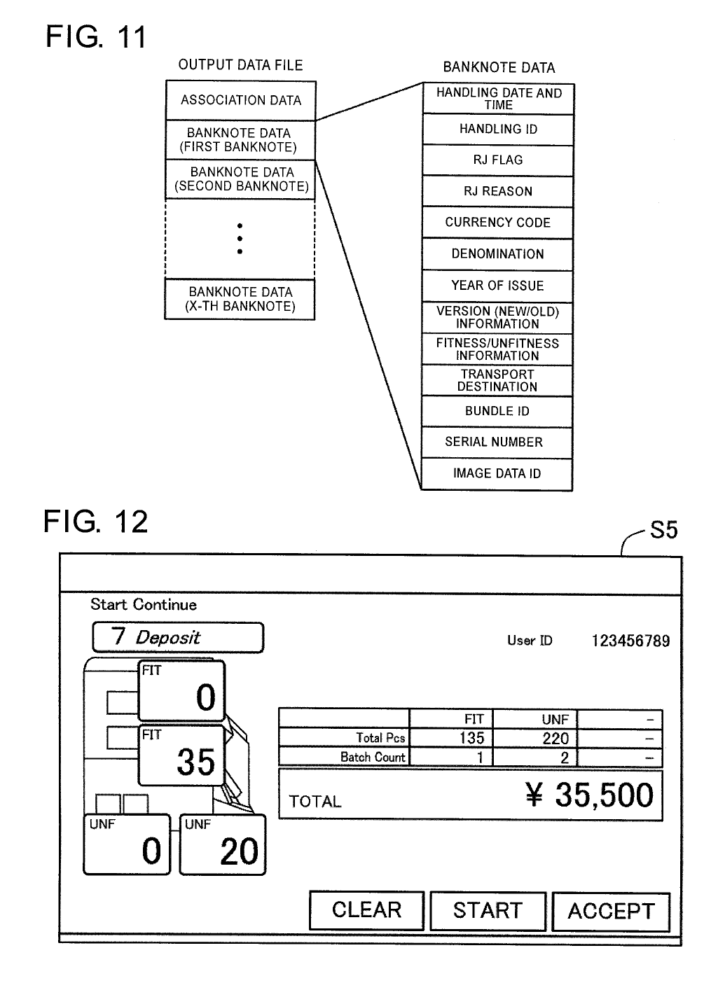

FIG. 11 conceptually illustrates a structure of the output data file. The output data file includes information, of a banknote (that is, banknote data), for at least one banknote. In the example illustrated in FIG. 11, the output data file includes the banknote data for X banknotes and the association data.

In the description herein, as shown in FIG. 11, the banknote data includes a handling date and time, a handling ID (ID: identification), an RJ flag (RJ: reject), an RJ reason, a currency code, a denomination, a year of issue, version (new/old) information, fitness/unfitness information, a transport destination, a bundle ID, a serial number, and an image data ID. The banknote data is not limited to the exemplary one shown in FIG. 11. The number of items to be included in the banknote data may be less than the number of items in the exemplary one shown in FIG. 11. An item which is not included in the exemplary one shown in FIG. 11 may be included in the banknote data.

Specifically, the handling date and time is information that represents a date and time when the banknotes are counted by the banknote handling apparatus 100. The handling ID is an ID which is assigned to a handling each time the banknote handling apparatus 100 performs the handling. The RJ flag indicates whether or not a banknote is a rejected note. The RJ reason is information that indicates whether the banknote determined as a rejected note is an undesignated banknote, an abnormal banknote, an abnormally transported banknote, or a counterfeit note. The year of issue represents a year when the banknote was issued, and can be represented as, for example, the last two digits of the year in the Western calendar. The version information is information representing a version of a banknote, as described above. The fitness/unfitness information is information that specifies fitness or unfitness of a banknote. Specifically, when the fitness/unfitness of a banknote is sorted into three levels, the fitness/unfitness information is information that indicates whether the recognized banknote is an ATM fit note, a Teller fit note, or an unfit note described above. The transport destination is information that indicates a stacker to which a banknote has been transported in the banknote handling apparatus 100, and indicates one, of the first bundling stacker 4A, the second bundling stacker 4B, the first non-bundling stacker 5A, or the second non-bundling stacker 5B, to which the banknote has been transported. The bundle ID is an ID which is assigned to bundled banknotes when the banknote handling apparatus 100 bundles the banknotes. The image data ID is an ID assigned for specifying image data which has been used for recognizing a banknote. The image data itself is not included in the output data file. Thus, a data amount of the output data file can be reduced. The image data is separately stored and managed, in the storage unit 131 of the banknote handling apparatus 100, or the higher-ranking terminal 140, so as to be associated with the image data ID.

Examples of items which can be additionally included in the exemplary banknote data shown in FIG. 11, include: information for indicating whether the banknote handling apparatus 100 has operated in the first mode or the second mode; an operator ID for specifying an operator who has operated the banknote handling apparatus 100; a handling machine ID for specifying the banknote handling apparatus 100; a cassette number (only for the cassette collection or the cassette loading); an ATM number (only for the ATM collection or the ATM loading); details of determination of a counterfeit note (abnormality in watermark, magnetic abnormality, abnormality in serial number, or the like); and the total monetary amount or the number of banknotes for each denomination in each batch or transaction.

The output data file is formed in a predetermined format. The format of the output data file can be changed. The format which can be changed includes a standard format for the banknote handling apparatus 100, a format suitable for data management in the higher-ranking terminal 140, and the like. In such a configuration, the format of the output data file can be formed so as to conform to a format required by a destination to which the information is outputted. The setting and changing of the format can be performed on a format setting screen displayed on the touch panel 17, which is not illustrated. The format of the output data file may be set for each task or for each of the stackers 4 and 5.

<Function During Operation of Banknote Handling Apparatus>

In the banknote handling apparatus 100, a configuration of a screen displayed on the touch panel 17 during operation of the banknote handling apparatus 100 is different according to a selected task. That is, during operation of the banknote handling apparatus 100, an interface suitable for a task being performed is provided to an operator.

FIG. 12 illustrates a screen S5 which is displayed on the touch panel 17 during operation of the banknote handling apparatus 100 in the depositing. On the screen S5, the kinds of banknotes to be stacked in the first and the second bundling stackers 4A and 4B and the first and the second non-bundling stackers 5A and 5B are indicated, and the number of the banknotes stacked in each of the stackers 4 and 5 is indicated. In the illustrated example, the fitness/unfitness levels are indicated as the kinds of the banknotes. Specifically, it is indicated that banknotes stacked in the bundling stacker 4 are fit notes, and 35 fit notes are stacked in the first bundling stacker 4A. Further, it is indicated that banknotes stacked in the non-bundling stacker 5 are unfit notes, and 20 unfit notes are stacked in the first non-bundling stacker 5A. On the screen S5, the total number of the fit notes having been handled, and the total number of the unfit notes having been handled are also indicated, and the number of times a batch has been obtained is indicated for each of the fit notes and the unfit notes. Further, the total monetary amount of banknotes having been handled is indicated.

After the handling has been completed and then an operator selects a confirmation (ACCEPT) button, one handling, that is, one transaction can be completed. For the following handling, banknotes are placed on the hopper unit 2 and a start (START) button is selected. Thus, the result of the counting in the previous handling is erased, and the following handling is started. In a case where the transaction is to be cancelled during the handling, an erasing (CLEAR) button is selected, whereby the result of the counting in the previous handling is erased, and the following handling can be started.

The configuration of the screen S5 is also used for the dispensing, the fitness/unfitness sorting, and the serial number recording, which are not illustrated.

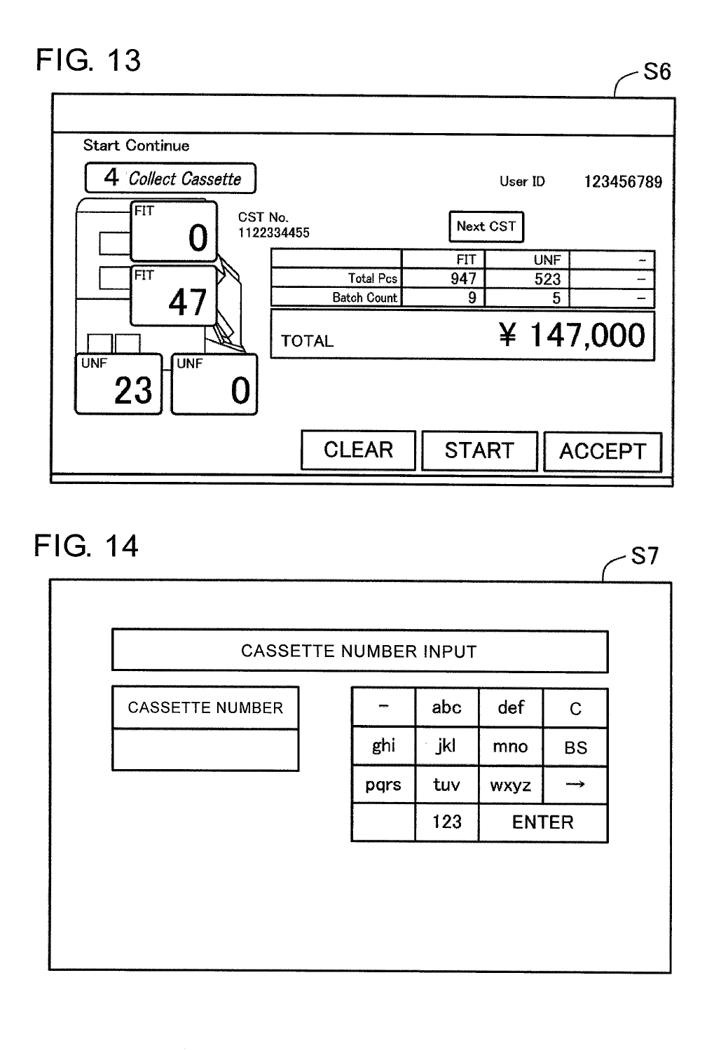

FIG. 13 illustrates a screen S6 which is displayed on the touch panel 17 during operation of the banknote handling apparatus 100 in the cassette collection or the ATM collection. Also on the screen S6, the fitness/unfitness level of banknotes stacked in each of the first and the second bundling stackers 4A and 4B and the first and the second non-bundling stackers 5A and 5B is indicated, and the number of the banknotes stacked in each of the stackers 4 and 5 is indicated. Further, the total number of fit notes having been handled and the total number of unfit notes having been handled are indicated, and the number of times a batch has been obtained is indicated for each of the fit notes and the unfit notes. Further, the total monetary amount of the banknotes having been handled is indicated. Further, a confirmation (ACCEPT) button, an erasing (CLEAR) button, and a start (START) button are provided. These buttons are the same as those on the screen S5 shown in FIG. 12.

On the screen S6 in the cassette collection, a cassette number (CST No.) of a cassette from which banknotes are currently collected is indicated, and a cassette change button (Next CST) for inputting a cassette number of a cassette from which banknotes are to be collected the following time after the current collection from the cassette is completed, is provided.

FIG. 14 illustrates a cassette number input screen S7 which is displayed on the touch panel 17 when the cassette change button is selected. A button for allowing a cassette number to be manually inputted is provided on the right side of the screen S7, and a cell in which the inputted cassette number is indicated is provided on the left side thereof. An operator designates, by operating the button, a cassette number that includes alphabetic characters and/or numeric characters, and selects an input (ENTER) button, whereby the cassette number of a cassette from which banknotes are to be collected the following time is inputted, and the inputted cassette number is indicated on the screen S6 shown in FIG. 13. Also when the cassette collection is started, the cassette number input screen S7 is displayed on the touch panel 17.

In the description herein, each time a cassette from which banknotes are to be collected is changed, an operator manually inputs the cassette number. However, for example, all the cassette numbers of the cassettes from which banknotes are to be collected may be previously inputted when the cassette collection is started, and the cassette number of a cassette from which banknotes are to be collected the following time may be selected from among the inputted cassette numbers when the cassette is changed. Further, instead of the cassette number being manually inputted, a code assigned to the cassette or a code on a voucher may be read by the code reader 144, and the cassette number obtained from the read code may be inputted.

In the ATM collection, on the screen S6, the ATM number is displayed instead of the cassette number, and an ATM change button is provided instead of the cassette change button. In the ATM collection, both the cassette change button and the ATM change button may be provided.

In the cassette collection, although a plurality of cassettes are handled, the handling of the plurality of cassettes may be operated as one transaction. In this operation, although the cassettes are changed during the handling, the total monetary amount on the screen S6 is not erased even when the cassettes are changed. Further, in the cassette collection in this operation, when banknotes are bundled, the banknotes from different cassettes may be stacked and bundled into one bundle of banknotes. That is, even if remaining banknotes are insufficient to be bundled when collection from one cassette is completed, the remaining banknotes can be added to banknotes collected from the following cassette to form one bundle of banknotes. In such an operation, a unit for generating the output data file may be each cassette or one transaction.

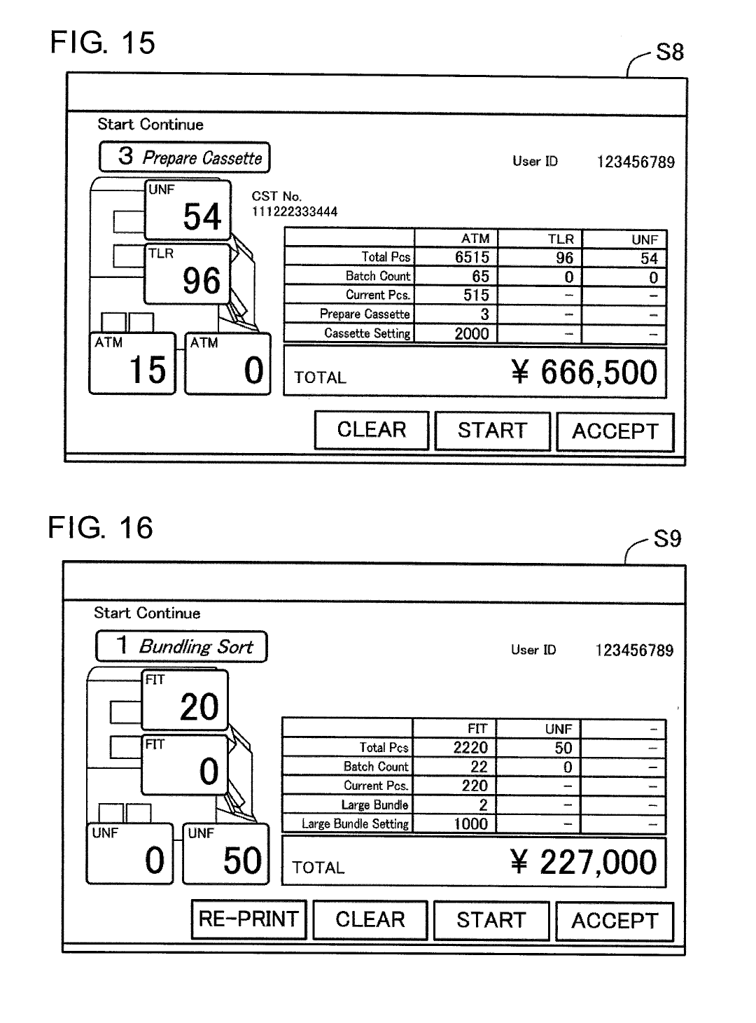

FIG. 15 illustrates a screen S8 which is displayed on the touch panel 17 during operation of the banknote handling apparatus 100 in the cassette loading and the ATM loading. Also on the screen S8, the fitness/unfitness level of banknotes stacked in each of the first and the second bundling stackers 4A and 4B and the first and the second non-bundling stackers 5A and 5B is indicated, and the number of banknotes stacked in each stacker is indicated.

Further, on the right side of the screen, the total number (in the illustrated example, divided into the number of ATM fit notes and the number of Teller fit notes) of fit notes having been handled and the total number of unfit notes having been handled are indicated, and the number of times a batch has been obtained is indicated for each of the fit notes and the unfit notes. The number of banknotes being currently stacked and the number of cassettes which have been already loaded with banknotes are indicated. Further, the set number (batch number) of banknotes to be loaded in the cassette is indicated (2000 in the illustrated example), and the total monetary amount of banknotes having been handled is indicated. Further, a confirmation (ACCEPT) button, an erasing (CLEAR) button, and a start (START) button are provided. On the screen S8, the cassette number of the cassette which is currently loaded is indicated. In the cassette loading, when the batch number of banknotes corresponding to the number of banknotes to be loaded in the cassette is reached, the screen S7 (see FIG. 14) for inputting a cassette number of a cassette to be loaded the following time is automatically displayed on the touch panel 17. When an operator has inputted, on the cassette number input screen S7, the cassette number of the cassette to be loaded the following time, the cassette loading is restarted. Also on the screen S8, similarly to the screen S6 shown in FIG. 13, a cassette change button for changing to a cassette to be loaded the following time may be provided.

In the ATM loading, instead of the cassette number, the ATM number is indicated on the screen S8. Further, when the batch number of banknotes corresponding to the number of banknotes to be loaded in the ATM is reached, a screen (not shown) for inputting an ATM number of an ATM to be loaded the following time is automatically displayed on the touch panel 17. Also on the screen for the ATM loading, an ATM change button for changing to an ATM to be loaded the following time may be provided.

FIG. 16 illustrates a screen S9 which is displayed on the touch panel 17 during operation of the banknote handling apparatus 100 in the large-bundle-of-fit/unfit-notes sorting. Also on the screen S9, the fitness/unfitness level of banknotes stacked in each of the first and the second bundling stackers 4A and 4B and the first and the second non-bundling stackers 5A and 5B is indicated, and the number of banknotes stacked in each stacker is indicated.

Further, on the screen S9, the total number of fit notes having been handled, and the total number of unfit notes having been handled, are indicated, and the number of times a batch has been obtained is indicated for each of the fit notes and the unfit notes. Further, the number of banknotes being currently stacked, the number of large bundles having been generated, and the set number of banknotes in a large bundle (1000 in the illustrated example) are indicated. Further, the total monetary amount of banknotes having been handled is also indicated. These are almost the same as indicated on the screen S8 shown in FIG. 15. On the screen S9, a confirmation (ACCEPT) button, an erasing (CLEAR) button, and a start (START) button are also provided, and a button (RE-PRINT button), for label printing, which is enabled for only the large-bundle-of-fit/unfit-notes sorting process is provided.

As described above, in the banknote handling apparatus 100, according to selection of a task, an interface corresponding to the task is provided to an operator. Specifically, in the cassette collection and the ATM collection, the control unit 120 causes the touch panel 17 to display the cassette number and the ATM number, and the cassette change button and the ATM change button, and causes the touch panel 17 to display the number input screen S7 (see FIG. 13, FIG. 14). Further, in the cassette loading and the ATM loading, the control unit 120 causes the touch panel 17 to display the cassette number and the ATM number, and causes the touch panel 17 to display the number input screen S7 (see FIG. 14, FIG. 15). As indicated as “providing of UI” in FIG. 4, according to selection of a task, changing to an interface corresponding to the task is automatically performed and the interface is provided to an operator, whereby usability is improved in the banknote handling apparatus 100.

<Control for Visually Guiding to Banknotes to be Taken Out>

In the cassette loading, the ATM loading, or the large-bundle-of-fit/unfit-notes sorting, an operator repeatedly performs taking-out of banknotes from the bundling stacker 4 or the non-bundling stacker 5 a plurality of times until one batch is obtained, as described above. Therefore, in a case where, for example, the batch is completed in each of the plurality of the stackers 4 and 5 in the banknote handling apparatus 100, it may be difficult to know a stacker from which banknotes are to be taken out.

In a case where the management unit for actual banknotes is associated with the unit for generating the output data file, if banknotes are taken out from an incorrect stacker, the actual banknotes may not correspond to banknote data. For example, in the cassette loading, the ATM loading, or the large-bundle-of-fit/unfit-notes sorting, in a case where, immediately after a batch is obtained in one stacker, a batch is completed in another stacker, if banknotes are firstly taken out from the other stacker, the order for the actual banknotes does not correspond to the order for the banknote data. Further, in a case where, immediately after the final batch is obtained (the specific batch process is completed), a batch is completed in another stacker, if banknotes are taken out from the other stacker, the actual banknotes may be loaded in an incorrect cassette or ATM, or may be included in an incorrect large bundle.

Therefore, in the banknote handling apparatus 100, when the batch number is reached in any of the stackers 4 and 5 during the cassette loading, the ATM loading, or the large-bundle-of-fit/unfit-notes sorting, a stacker from which banknotes are to be taken out is visually indicated to an operator. In the banknote handling apparatus 100, an operator is visually guided to a stacker from which banknotes are to be taken out, by a plurality of means.

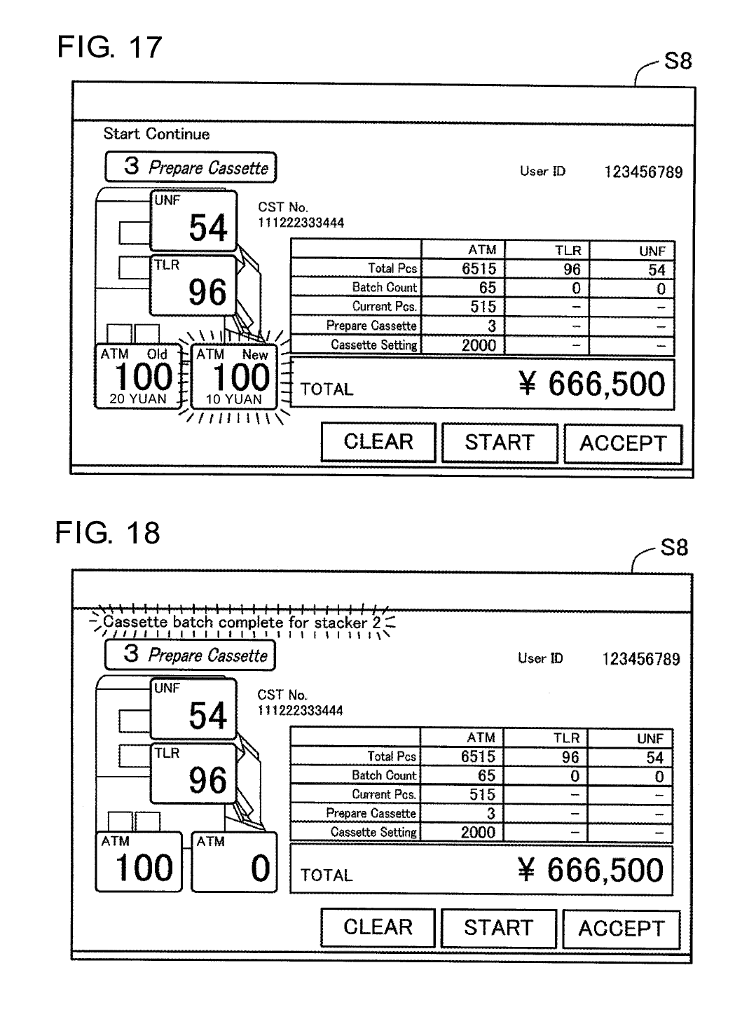

FIG. 17 illustrates a screen S8 which is displayed on the touch panel 17 in the cassette loading. The configuration of the screen is the same as that of the screen S8 shown in FIG. 15. In the example shown in FIG. 17, in both the first non-bundling stacker 5A and the second non-bundling stacker 5B, the batch number (100) has been reached. The control unit 120 displays, in a blinking manner, the number of banknotes in a stacker, among the two stackers 5A and 5B in which the batch number has been reached, from which banknotes are to be firstly taken out. In the example shown in FIG. 17, the display of the first non-bundling stacker 5A blinks. Thus, a stacker from which banknotes are to be firstly taken out is visually indicated to an operator.

On the screen S8, information of the first bundling stacker 4A, the second bundling stacker 4B, the first non-bundling stacker 5A, and the second non-bundling stacker 5B is indicated so as to correspond to the actual layout of the stackers 4 and 5 in the banknote handling apparatus 100, and a stacker from which banknotes are to be taken out is clearly indicated in the blinking manner. Therefore, an operator is allowed to take out banknotes from a correct stacker without making a mistake in stacker. Instead of the blinking display, a color of display of the number of banknotes in the stacker may be made different from colors for the other stackers, to visually indicate a stacker from which banknotes are to be taken out.

Further, on the screen S8, the fitness/unfitness level for the stacked banknotes and a plurality of kinds of pieces of information other than the fitness/unfitness level are indicated for each of the stackers 5A and 5B. In the illustrated example, “New” means that the banknotes are new version banknotes, and “Old” means that the banknotes are old version banknotes. Thus, an operator can know a version of banknotes to be taken out and understand that the banknotes corresponding to the version are to be taken out from the stacker. Further, on the screen S8 in this example, information of a denomination of the banknotes is also indicated (“20 yuan” and “10 yuan” in the illustrated example). Thus, the operator can know the denomination of the banknotes to be taken out.

In addition to the display on the touch panel 17, in the banknote handling apparatus 100, denominations and versions of banknotes stacked in the first non-bundling stacker 5A and the second non-bundling stacker 5B are displayed on the liquid crystal panels 18 mounted near the non-bundling stacker 5. Thus, an operator is allowed to correctly recognize the stacker from which banknotes are to be taken out, on the basis of the contents displayed on the touch panel 17 and the contents displayed on the liquid crystal panel 18.

Further, in the banknote handling apparatus 100, the illumination device 46 or 55 blinks or is lit up for the stacker 4 or 5 from which banknotes are to be taken out. Thus, the banknotes to be taken out are illuminated, whereby an operator is allowed to more correctly recognize the stacker from which banknotes are to be taken out.

In addition, in the banknote handling apparatus 100, when a stacker from which banknotes are to be taken out is the bundling stacker 4, the lock mechanism 44 is caused to enter an unlocking state, to open the door 43 (see FIG. 1). Thus, the bundling stacker 4 from which banknotes are to be taken out can be more clearly indicated, and taking-out of the banknotes is allowed. Meanwhile, when a stacker from which banknotes are to be taken out is the non-bundling stacker 5, the pushing mechanism 54 pushes the stacked banknotes (see FIG. 1). Thus, the non-bundling stacker 5 from which banknotes are to be taken out is more clearly indicated.

In the banknote handling apparatus 100, a visually guiding unit is implemented by: the touch panel 17; the liquid crystal panel 18; the door 43, the lock mechanism 44, and the illumination device 46 of the bundling stacker 4; and the pushing mechanism 54 and the illumination device 55 of the non-bundling stacker 5.

The banknote handling apparatus 100 may have at least one of the plurality of means for visually guiding an operator.

The stacking sensors 45 and 52 detect that banknotes have been taken out from the stackers 4 and 5, respectively. When banknotes are taken out from a correct stacker, a stacker from which banknotes are to be taken out the following time is visually indicated to an operator, an operation of the banknote handling apparatus 100 is restarted, or the banknote handling apparatus 100 enters a stand-by state.

Meanwhile, the stacking sensors 45 and 52 can also detect that banknotes are taken out from an incorrect stacker. When banknotes are taken out from an incorrect stacker, the control unit 120 may indicate, on the touch panel 17, that banknotes are taken out from an incorrect stacker (that is, performs warning by display). Further, the warning to an operator may be performed by sound by means of the buzzer 145. A warning unit is implemented by each of the touch panel 17 and the buzzer 145. Further, restart of the operation of the banknote handling apparatus 100 may be prohibited. In a case where the banknotes taken out from an incorrect stacker is returned to the original position, and banknotes are taken out from a correct stacker, a stacker from which banknotes are to be taken out the following time is visually indicated to an operator, an operation of the banknote handling apparatus 100 is restarted, or the banknote handling apparatus 100 enters a stand-by state, as described above.

Control for clearly indicating a stacker from which banknotes are to be taken out may be performed in a normal batch process as well as the fitness/unfitness batch process. Further, the control may be performed not only in the batch process but also after one transaction in each of various handlings is ended, in order to prevent banknotes from being left in a stacker without taking out the banknotes.

<Control for Clearly Indicating Completion of Batch Process>

As described above, in the large-bundle-of-fit/unfit-notes sorting, the cassette loading, or the ATM loading, a normal batch process is repeatedly performed a plurality of times. Therefore, an operator cannot easily know when the specific batch process has been completed. Specifically, the operator cannot easily know when the batch number of banknotes for a large bundle has been reached, when the batch number of banknotes to be loaded in a cassette has been reached, or when the batch number of banknotes to be loaded in an ATM has been reached. Therefore, as shown in FIG. 18, in the large-bundle-of-fit/unfit-notes sorting, the cassette loading, or the ATM loading, when the batch number (hereinafter, may be referred to as “specific batch number”) of banknotes in the specific batch process has been reached, an operator may be notified thereof by display of the touch panel 17. In the illustrated example, the screen S8 displayed in the cassette loading, is indicated, and it is indicated that the specific batch number set for the cassette loading has been reached, and a stacker in which the final normal batch has been obtained is indicated (“cassette batch complete for stacker 2”). Display (hereinafter, may be referred to as “specific batch number reaching display”) indicating that the specific batch number has been reached, may be highlighted as necessary (for example, blinking display or the like).

As described above, in the large-bundle-of-fit/unfit-notes sorting, the cassette loading, or the ATM loading, in a case where the feeding stop function is ON, the feeding by the banknote handling apparatus 100 is stopped under the condition that the specific batch process has been completed. Further, the feeding by the banknote handling apparatus 100 may be stopped until an operator performs restart operation after banknotes have been taken out from the stacker in which the final normal batch has been obtained. In this case, the specific batch number reaching display may be continued until the operator performs the restart operation.

Meanwhile, in a case where the feeding stop function is OFF, the feeding by the banknote handling apparatus 100 is not stopped even when the specific batch process has been completed. Therefore, immediately after banknotes have been taken out from a stacker, banknotes may be stacked anew in the stacker, the specific batch number reaching display may immediately disappear, and information of the banknotes stacked anew may be displayed. Thus, an operator may miss the specific batch number reaching display. Therefore, the specific batch number reaching display may be continued for a predetermined time period after the banknotes have been taken out from the stacker. Thus, the operator can be prevented from missing the display, and each of the large-bundle-of-fit/unfit-notes sorting, the cassette loading, and the ATM loading can be correctly performed.

<Output Time for Output Data File>

When the banknote handling apparatus 100 performs handling, an output data file is generated, in the background, in generation units corresponding to the selected task (see FIG. 4). In the banknote handling apparatus 100, the control unit 120 outputs the generated output data file via the communication unit 132 to the higher-ranking terminal 140. Instead of or in addition to the generated output data file being outputted to the higher-ranking terminal 140, the control unit 120 may output the generated output data file via the input/output unit 133 to the memory card 142 or the storage drive 143, or may print the banknote data or the like by the printer 141. Further, the banknote data or the like may be displayed on a not-illustrated external display. By the control unit 120, an output unit for outputting the output data file to the outside of the banknote handling apparatus 100 is implemented.

The generating unit for generating the output data file is different so as to correspond to each task. Therefore, the generation time is also different so as to correspond to each task. In the banknote handling apparatus 100, if the output time for the output data file is uniform, the output data file may not be outputted at an appropriate time. The output time for the output data file needs to be changed according to the generating unit for generating the output data file being changed depending on the tasks.

Therefore, in the banknote handling apparatus 100, a plurality of output conditions are preset, and the output time for the output data file is controlled on the basis of an output condition selected from among the plurality of output conditions. Specifically, the control unit 120 is configured so as to control a time of the output by the control unit 120 such that the output data file is outputted after the output condition selected as appropriate has been satisfied. Specifically, in the first mode, a condition for outputting the output data file is set so as to correspond to the task. By a task being selected, the output condition is automatically selected. In the second mode, an operator selects one output condition from among a plurality of conditions.

An output condition, for the output data file, which is set so as to correspond to each task in the first mode will be firstly described with reference to FIG. 4. The control unit 120 forms a condition selection unit that selects one condition from among a plurality of conditions according to the correspondence such that the control unit 120 causes the banknote handling apparatus 100 to operate, as described above.

The output condition for each of the depositing and the dispensing is that one transaction is completed. One transaction is completed by the confirmation button being selected on the screen S5 shown in FIG. 12. In other words, the output condition may be a condition that an operator has performed an operation for instruction for outputting the output data file. At or after a time when the confirmation button is selected, the control unit 120 of the banknote handling apparatus 100 outputs the output data file generated for each transaction. “At or after a time when the confirmation button is selected” includes a time when the confirmation button is selected and times after that time. The same applies to the following description. Therefore, the control unit 120 may output the output data file at a time when the confirmation button is selected, or the control unit 120 may output the output data file after a predetermined delay time has elapsed since the selection of the confirmation button. The completion of a transaction is not limited to completion by selecting the confirmation button on the screen S5. For example, the transaction may be completed according to an instruction from the higher-ranking terminal 140. Further, in a case where an ID by which a customer is identified, can be inputted to the higher-ranking terminal 140 or on the screen S5 shown in FIG. 12, when an ID by which another customer is identified is inputted for the following depositing or dispensing, the transaction may be completed.

The output condition for the fitness/unfitness sorting is that one of a condition that a predetermined time (for example, 10 minutes) elapses after the fitness/unfitness sorting by the banknote handling apparatus 100 has been performed lastly, or a condition that the number of banknotes for which the fitness/unfitness sorting has been performed has reached a predetermined number (for example, 2000) of banknotes, is satisfied. At a time when the condition is satisfied or at a predetermined time after the condition has been satisfied, the control unit 120 outputs, for each of the fitness and the unfitness levels, the output data file for the handlings which have been performed. As the output condition for the fitness/unfitness sorting, an operator may select one of the above-described two conditions. In this case, the control unit 120 outputs the output data file at or after a time when the selected condition is satisfied.

In the large-bundle-of-fit/unfit-notes sorting, in a case where the handled actual banknotes can be managed in large bundle units, the output condition is that the specific batch process for generating one large bundle of banknotes is completed. Specifically, the control unit 120 outputs the output data file generated in the large bundle units at a time when the specific batch process for generating one large bundle of banknotes is completed, or at a predetermined time after the specific batch process for generating one large bundle of banknotes has been completed (a time when the specific batch process is completed, or when a predetermined time has elapsed after the time of the completion). In the large-bundle-of-fit/unfit-notes sorting, when the feeding stop function is ON, the control unit 120 may output the output data file at or after a time when the final normal batch process has been completed in the specific batch process. Further, the control unit 120 may output the output data file at or after a time when an operator has taken out banknotes from the stacker 4 or 5 in which the final normal batch process has been completed. Furthermore, the control unit 120 may output the output data file at or after a time when an operator has made an instruction for restarting the following specific batch process. Moreover, when the feeding stop function is OFF, the control unit 120 may output the output data file at a time when the final normal batch process has been completed in the specific batch process or at an appropriate time after the final normal batch process has been completed in the specific batch process.

A case where, for example, 5100 banknotes are taken into the banknote handling apparatus 100 in the large-bundle-of-fit/unfit-notes sorting in which the specific batch number is set as 1000, is assumed. In this case, the control unit 120 sequentially outputs banknote data corresponding to 5000 banknotes (1000 banknotes×5 bundles=5000 banknotes), as five output data files. Meanwhile, 100 (5100 banknotes−5000 banknotes=100 banknotes) remaining insufficient banknotes are managed as banknotes for which the management unit for actual banknotes is “other than the large bundles of banknotes”. The control unit 120 may output the output data file of the remaining insufficient banknotes when the large-bundle-of-fit/unfit-notes sorting has been completed, and an operator has selected the confirmation button displayed on the touch panel 17. Alternatively, the control unit 120 may output the output data file of the remaining insufficient banknotes under the condition that a predetermined time (for example, 10 minutes) elapses after data has last been written into the output data file.

The output condition for the cassette collection is that collecting for one cassette is completed. As described above, the cassette change button is selected on the screen S6 shown in FIG. 13 when the collecting for one cassette has been completed. The control unit 120 outputs the output data file generated in units of cassettes to be collected, at a time when the cassette change button is selected, or at a predetermined time after the cassette change button has been selected. Further, also when the collecting for one cassette has been completed, and an operator selects the confirmation button displayed on the touch panel 17, the control unit 120 outputs the output data file generated in units of cassettes to be collected.

The output condition for the ATM collection is similar to the output condition for the cassette collection, and is that collecting for one ATM is completed. Therefore, the control unit 120 outputs the output data file generated in units of ATMs from which banknotes are collected, at a time when the ATM change button is selected on the screen S6 or at a predetermine time after the ATM change button has been selected on the screen S6. Further, also when the collecting for one ATM has been completed, and an operator selects the confirmation button displayed on the touch panel 17, the control unit 120 outputs the output data file generated in units of ATMs from which banknotes are collected.

In the cassette loading, as described above, two kinds of output data files, that is, the output data file generated in loaded cassette units, and the output data file for banknotes other than the loaded banknotes, are generated. The output condition for the output data file generated in loaded cassette units is that the specific batch process for loading one cassette has been completed. The control unit 120 outputs the output data file in cassette units, at a time when the specific batch process is completed, or at a predetermined time after the specific batch process has been completed. In the cassette loading, when the feeding stop function is ON, the control unit 120 may output the output data file in loaded cassette units, at or after a time when the specific batch number has been reached, or at or after a time when an operator has taken out banknotes from the stacker 4 or 5 in which the final normal batch process has been completed in the specific batch process, or at or after a time when an operator has made an instruction for restarting the following specific batch process, as described above. Further, when the feeding stop function is OFF, the control unit 120 may output the output data file for the loaded cassette at a time when the specific batch number is reached or at an appropriate time after the specific batch number has been reached.

Meanwhile, the output condition for the output data file for banknotes other than the loaded banknotes, is that at least one of a condition that a predetermined time (for example, 10 minutes) elapses after counting has last been performed by the banknote handling apparatus 100, or a condition that the number of banknotes for which counting has been performed, has reached a predetermined number (for example, 2000) of banknotes, is satisfied. The control unit 120 outputs the output data file when or after one of the conditions has been satisfied. An operator may select one of the above two conditions. Further, also when an operator selects the confirmation button displayed on the touch panel 17, the control unit 120 outputs the output data files having been generated.

The output condition for the ATM loading is similar to the output condition for the cassette loading. The output condition for the output data file generated in units of loaded ATMs is that loading for one ATM is completed. Further, the output condition for a data file of banknotes other than loaded banknotes is that at least one of a condition that a predetermined time (for example, 10 minutes) elapses after counting has last been performed by the banknote handling apparatus 100, or a condition that the number of banknotes for which counting has been performed, has reached a predetermined number (for example, 2000) of banknotes, is satisfied. Further, also when an operator selects the confirmation button displayed on the touch panel 17, the control unit 120 outputs the output data files having been generated.

The output condition for the serial number recording is that at least one of a condition that a predetermined time (for example, 10 minutes) elapses after handling has last been performed by the banknote handling apparatus 100, or a condition that the number of banknotes for which counting has been performed has reached a predetermined number (for example, 2000) of banknotes, is satisfied. Further, also when an operator selects the confirmation button displayed on the touch panel 17, the control unit 120 outputs the output data files having been generated.

As described above, in the first mode, according to a task being selected, the output condition corresponding to the selected task is automatically set. Meanwhile, in the second mode, an operator is allowed to select a condition for outputting the output data file.

In the banknote handling apparatus 100, the output conditions that can be selected in the second mode are set as follows. That is, the output conditions include (1) a condition that a transaction has been completed, (2) a condition that a batch has been obtained, (3) a condition that banknotes have been taken out from the stacker 4 or 5, (4) a condition that the recognition unit 3 has obtained information about a banknote, (5) a condition that an operator has made an instruction for outputting the output data file, (6) a condition that a predetermined time elapses after banknotes have been handled lastly, and (7) a condition that the number of banknotes having been handled has reached a predetermined number of banknotes.

Among them, (1) in a case where the control unit 120 outputs the output data file under the condition that a transaction has been completed, the output data file includes data of all the banknotes for the transaction.

(2) In a case where the control unit 120 outputs the output data file under the condition that a batch has been obtained, the output data file includes data of all the banknotes included in the batch. In this case, the control unit 120 may assign a batch ID for specifying the batch, and the output data file may include the batch ID. In the batch process, similarly to the above-described large-bundle-of-fit/unfit-notes sorting, the batch process (specific batch process) in which the batch number of banknotes are set so as to exceed the stacking capacity of banknotes stacked in each of the stackers 4 and 5, is also included.

Output of the output data file for remaining banknotes which are insufficient for the batch may be stopped. The output data file may be outputted based on a predetermined condition including a condition that an instruction is separately made by an operator, being satisfied.

(3) In a case where the control unit 120 outputs the output data file under the condition that banknotes have been taken out from the stacker 4 or 5, the output data file includes data of all the banknotes having been taken out. In this case, the control unit 120 may assign a taking-out ID for specifying the taking-out, and the output data file may include the taking-out ID.

When the output condition is the condition that banknotes have been taken out, unlike a case where the output condition is the condition that a batch has been obtained as described above, the output data file for remaining banknotes which are insufficient for the batch is outputted when the banknotes are taken out from the stacker or at any time after the banknotes have been taken out therefrom.

(4) In a case where the control unit 120 outputs the output data file under the condition that the recognition unit 3 has obtained information about a banknote, the output data file includes information about the one banknote. In this case, the output of the output data file is performed at any time in synchronization with recognition by the recognition unit 3.

(5) An operator's instruction for outputting the output data file includes selection of the confirmation button on, for example, the screen S5 shown in FIG. 12, and selection of the cassette or the ATM change button on the screen S6 shown in FIG. 13. In a case where the control unit 120 outputs the output data file under the condition that an operator makes an instruction, the output data file includes banknote data that has not been outputted. For example, an “output button” is separately provided, and data of remaining banknotes which are insufficient for a batch, or the like may be outputted under the condition that the output button is operated. The output button may be a button implemented by hardware, or may be a button displayed on the touch panel 17.

(6) In a case where the control unit 120 outputs the output data file under the condition that a predetermined time elapses after banknotes have been handled lastly, the output data file includes banknote data that has not been outputted.

(7) In a case where the control unit 120 outputs the output data file under the condition that the number of banknotes having been handled has reached a predetermined number of banknotes, the output data file includes banknote data that has not been outputted.

For example, one of the condition (2) and the condition (3) is properly used, whereby output of information about the remaining banknotes which are insufficient for a batch may be stopped until the batch is obtained the following time, or output may be separately performed without waiting for obtaining of the batch. Thus, both a customer who desires that data be managed in batch units, and a customer who considers that handling at real time is important can be supported, and it is possible to conform to specifications, for data management, of the higher-ranking terminal 140.

An operator may set one of the conditions (1) to (7) as the output condition, or may select a plurality of conditions from among the conditions (1) to (7) and set an AND condition of the selected plurality of conditions as the output condition, or set an OR condition of the selected plurality of conditions as the output condition.

Thus, in the banknote handling apparatus 100, in each of the first mode and the second mode, a plurality of conditions are set for the condition for outputting the output data file. The control unit 120 controls a time when the output data file is outputted, on the basis of a condition selected from among the plurality of conditions. Therefore, the output data files generated at times which are different according to tasks performed using the banknote handling apparatus 100 can be each outputted at an appropriate time. That is, the output data file can be outputted at an appropriate time so as to correspond to the banknote data included in the output data file. Further, information can be outputted at a time appropriate for a task in the first mode, whereas a time can be adjusted as appropriate according to a customer's request or the like in the second mode.

The output data file may be, for example, encrypted and outputted to the higher-ranking terminal 140 or an external device, or the file may be compressed and outputted to the higher-ranking terminal 140 or an external device.

### Other Embodiments

In the above embodiment, the banknote handling apparatus 100 is described as a banknote processing machine having a predetermined configuration. However, the banknote handling apparatus is not limited thereto. The technique disclosed herein is applicable to various banknote handling apparatuses.

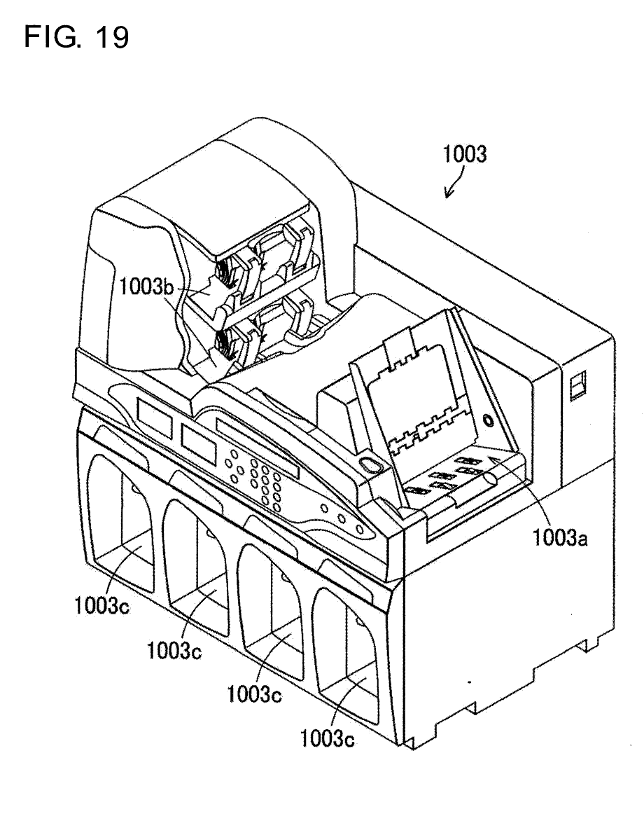

FIG. 19 illustrates a banknote processing machine 1003 as an example of the banknote handling apparatus. The banknote processing machine 1003 is configured to sort and count a plurality of banknotes having been inserted, according to predetermined sorting contents. The banknote processing machine 1003 include: a hopper 1003a through which banknotes are inserted; two reject units 1003b for discharging rejected notes; and four stacking units 1003c in each of which banknotes are stacked. Inside the banknote processing machine 1003, a recognition unit is provided. The banknote processing machine 1003 has substantially the same functions as the banknote handling apparatus 100 although the structure is different therebetween.

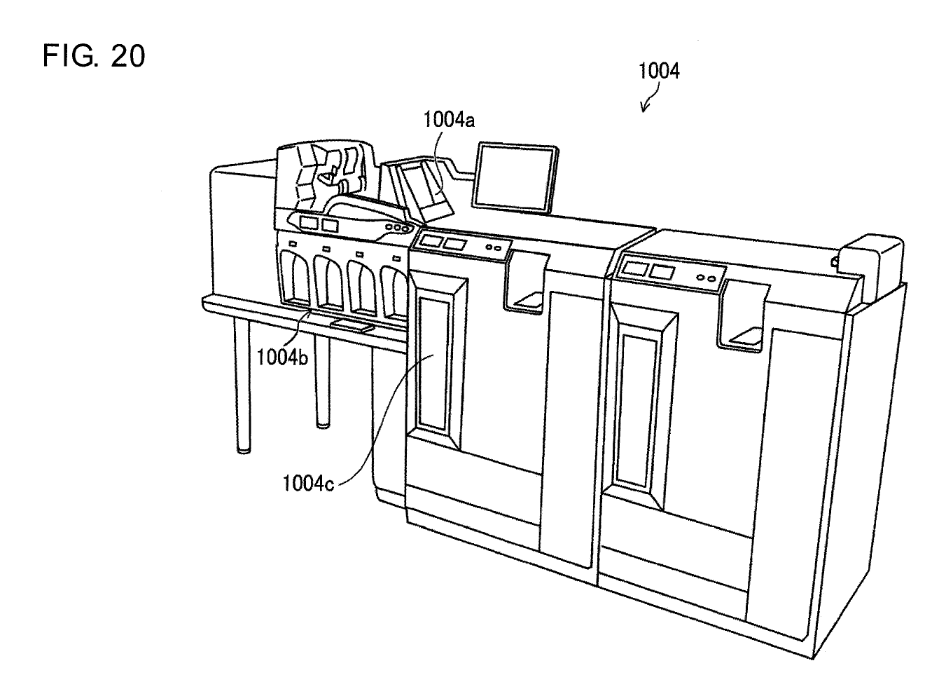

FIG. 20 illustrates a banknote sorting and bundling apparatus 1004 as an example of the banknote handling apparatus. The banknote sorting and bundling apparatus 1004 is configured such that, in depositing, the inserted banknotes are sorted and stacked for each stacking category and each kind of banknote, and banknotes having been sorted and stacked for each stacking category and each kind of the banknote, are bundled with a tape. The banknote sorting and bundling apparatus 1004 includes: an insertion unit 1004a through which banknotes are inserted; a plurality of stacking units 1004b in each of which banknotes are stacked; and a discharge unit 1004c that discharges the bundled banknotes. Inside the banknote sorting and bundling apparatus 1004, a recognition unit is provided. The banknote sorting and bundling apparatus 1004 partially has substantially the same function as the banknote handling apparatus 100 although the structure is different therebetween.

What is claimed is:

1. A banknote handling apparatus comprising:
a recognition unit configured to obtain information of a banknote;
a handling unit configured to perform handling on the basis of the information obtained by the recognition unit;
a control unit configured to output, to an outside of the apparatus, the information obtained by the recognition unit; and
a condition selection unit configured to select a condition from among a plurality of predetermined conditions, as a condition for outputting the information, wherein
the control unit controls a time at which the information is outputted, on the basis of the condition selected by the condition selection unit.

2. The banknote handling apparatus according to claim 1, wherein one of the plurality of conditions is a condition that a batch process in which a set batch quantity of banknotes are stacked in a stacking unit, is completed.

3. The banknote handling apparatus according to claim 2, wherein
the batch process includes a specific batch process in which a batch quantity of banknotes are stacked, and the batch number exceeds a stacking capacity of banknotes stacked in the stacking unit, and
stacking banknotes in the stacking unit and taking out the banknotes from the stacking unit are performed a plurality of times, and
the control unit determines, when a cumulative number of banknotes having been stacked in the stacking unit reaches the batch quantity, that the batch process has been completed, and outputs the information.

4. The banknote handling apparatus according to claim 1, wherein one of the plurality of conditions is a condition that one transaction is completed in a task which is performed by using the handling by the handling unit.

5. The banknote handling apparatus according to claim 1, wherein
the plurality of conditions include at least one of:
(1) banknotes are taken out from the stacking unit,
(2) the recognition unit obtains the information,
(3) a user performs an operation for instruction for outputting the information,
(4) the number of banknotes handled by the handling unit reaches a predetermined number of banknotes, and
(5) a predetermined time elapses after the handling has been performed lastly by the handling unit.

6. The banknote handling apparatus according to claim 1, comprising
a task selection unit configured to select a task from among a plurality of predetermined tasks, as a task which is performed by using the handling by the handling unit, wherein
the condition selection unit automatically selects a condition from among the plurality of conditions, on the basis of the task selected by the task selection unit.

7. The banknote handling apparatus according to claim 1, wherein, on the basis of an operation performed by a user who selects a condition from among the plurality of conditions, the condition selection unit selects the condition.

8. The banknote handling apparatus according to claim 1, wherein the control unit outputs the information in a predetermined format, and allows the format to be modifiable.
